(19) United States
(12) Patent Application Publication
(10) Pub. No.: US 2026/0082290 A1
(43) Pub. Date: Mar. 19, 2026

(54) TECHNIQUES FOR USER EQUIPMENT ASSISTED CELL SELECTION

(71) Applicant: QUALCOMM Incorporated, San Diego, CA (US)

(72) Inventors: Meilong JIANG, Westfield, NJ (US); Navid ABEDINI, Basking Ridge, NJ (US); Jianghong LUO, Skillman, NJ (US); Naeem AKL, Bridgewater, NJ (US); Ahmed BEDEWY, Hillsborough, NJ (US)

(21) Appl. No.: 18/887,000

(22) Filed: Sep. 16, 2024

(51) Int. Cl. H04W 36/00

(52) U.S. Cl. CPC H04W 36/0085; H04W 36/0058

(57) ABSTRACT

Methods, systems, and devices for wireless communications are described. A first user equipment (UE) may perform a first cell search operation to initiate selection of a first cell associated with a network entity. The first UE may obtain cell selection information that facilitates performance, by one or more second UEs, of a second cell search operation based on performing the first cell search operation. The first UE and the one or more second UEs may be located within a threshold distance of each other. The second cell search operation may initiate selection of the first cell and may be simplified with respect to the first cell search operation. The first UE may transmit the cell selection information to the one or more second UEs of the set of UEs. The first UE and the one or more second UEs may establish respective connections with the network entity.

### FIELD OF TECHNOLOGY

The present disclosure, for example, relates to wireless communication systems, including techniques for user equipment (UE) assisted cell selection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first user equipment (UE) is described. The method may include performing a first cell search operation to initiate selection of a first cell associated with a network entity, obtaining cell measurement-related information that facilitates performance, by one or more second UEs of a set of UEs, of a second cell search operation to initiate selection of the first cell based on performing the first cell search operation, where the second cell search operation is simplified with respect to the first cell search operation, and transmitting the cell measurement-related information to the one or more second UEs of the set of UEs based on obtaining the cell measurement-related information, where the first UE and the one or more second UEs are included in the set of UEs based on the first UE and the one or more second UEs being within a threshold distance of each other.

A first UE for wireless communications is described. The first UE may include one or more memories storing processor executable code, and one or more processors coupled with the one or more memories. The one or more processors may individually or collectively be operable to execute the code to cause the first UE to perform a first cell search operation to initiate selection of a first cell associated with a network entity, obtain cell measurement-related information that facilitates performance, by one or more second UEs of a set of UEs, of a second cell search operation to initiate selection of the first cell based on performing the first cell search operation, where the second cell search operation is simplified with respect to the first cell search operation, and transmit the cell measurement-related information to the one or more second UEs of the set of UEs based on obtaining the cell measurement-related information, where the first UE and the one or more second UEs are included in the set of UEs based on the first UE and the one or more second UEs being within a threshold distance of each other.

Another first UE for wireless communications is described. The first UE may include means for performing a first cell search operation to initiate selection of a first cell associated with a network entity, means for obtaining cell measurement-related information that facilitates performance, by one or more second UEs of a set of UEs, of a second cell search operation to initiate selection of the first cell based on performing the first cell search operation, where the second cell search operation is simplified with respect to the first cell search operation, and means for transmitting the cell measurement-related information to the one or more second UEs of the set of UEs based on obtaining the cell measurement-related information, where the first UE and the one or more second UEs are included in the set of UEs based on the first UE and the one or more second UEs being within a threshold distance of each other.

A non-transitory computer-readable medium storing code for wireless communications is described. The code may include instructions executable by one or more processors to perform a first cell search operation to initiate selection of a first cell associated with a network entity, obtain cell measurement-related information that facilitates performance, by one or more second UEs of a set of UEs, of a second cell search operation to initiate selection of the first cell based on performing the first cell search operation, where the second cell search operation is simplified with respect to the first cell search operation, and transmit the cell measurement-related information to the one or more second UEs of the set of UEs based on obtaining the cell measurement-related information, where the first UE and the one or more second UEs are included in the set of UEs based on the first UE and the one or more second UEs being within a threshold distance of each other.

In some examples of the method, first UEs, and non-transitory computer-readable medium described herein, the cell measurement-related information includes cell measurement configuration information, cell measurement result information, or both.

Some examples of the method, first UEs, and non-transitory computer-readable medium described herein may further include operations, features, means, or instructions for obtaining system information that facilitates the performance of the second cell search operation and transmitting the system information to the one or more second UEs of the set of UEs based on obtaining the system information.

In some examples of the method, first UEs, and non-transitory computer-readable medium described herein, obtaining the system information may include operations, features, means, or instructions for obtaining the system information during a connection establishment operation with the network entity or based on a network configuration change at the network entity.

Some examples of the method, first UEs, and non-transitory computer-readable medium described herein may further include operations, features, means, or instructions for receiving, from a second UE of the one or more second UEs, a request for the system information, where transmitting the system information may be based on receiving the request.

Some examples of the method, first UEs, and non-transitory computer-readable medium described herein may further include operations, features, means, or instructions for transmitting, to the network entity, a request for the system information, where obtaining the system information may be based on transmitting the request.

In some examples of the method, first UEs, and non-transitory computer-readable medium described herein, obtaining the cell measurement-related information may include operations, features, means, or instructions for receiving one or more synchronization signals from the network entity based on performing the first cell search operation and decoding a reference signal based on receiving the one or more synchronization signals, where the transmitted cell measurement-related information includes first information associated with the one or more synchronization signals, second information associated with the reference signal, or both.

Some examples of the method, first UEs, and non-transitory computer-readable medium described herein may further include operations, features, means, or instructions for establishing a connection with the network entity in accordance with the first information, the second information, or both, where transmitting the cell measurement-related information may be based on establishing the connection.

In some examples of the method, first UEs, and non-transitory computer-readable medium described herein, obtaining the cell measurement-related information may include operations, features, means, or instructions for receiving one or more system information blocks (SIBs) associated with the first cell that include first information associated with one or more second cells different than the first cell, the transmitted cell measurement-related information including the first information.

In some examples of the method, first UEs, and non-transitory computer-readable medium described herein, the first information includes cell remeasurement-related information that includes priority information associated with the one or more second cells, one or more threshold values associated with the one or more second cells, one or more offsets associated with the one or more second cells, frequency information, one or more measurement configurations associated with the one or more second cells, or any combination thereof.

Some examples of the method, first UEs, and non-transitory computer-readable medium described herein may further include operations, features, means, or instructions for selecting a second cell of the one or more second cells, where transmitting the cell measurement-related information may be based on selecting the second cell.

In some examples of the method, first UEs, and non-transitory computer-readable medium described herein, the transmitted cell measurement-related information further includes second information associated with the one or more second cells, the second information indicative of a search window for synchronization signal blocks (SSBs), a list of second cells that may be detectable by the first UE, a power change of a second cell, a list of second cells that may be not to be considered for cell reselection, or any combination thereof.

In some examples of the method, first UEs, and non-transitory computer-readable medium described herein, transmitting the cell measurement-related information may include operations, features, means, or instructions for transmitting the cell measurement-related information via a broadcast channel, a sidelink channel, a wireless local-area network (WLAN), a Bluetooth link, or any combination thereof.

In some examples of the method, first UEs, and non-transitory computer-readable medium described herein, the threshold distance may be associated with a set of one or more beams of the network entity, the first UE and the one or more second UEs being located within the set of one or more beams.

In some examples of the method, first UEs, and non-transitory computer-readable medium described herein, the threshold distance may be associated with a set of one or more cells of the network entity, the first UE and the one or more second UEs being located within the set of one or more cells of the network entity.

In some examples of the method, first UEs, and non-transitory computer-readable medium described herein, at least one of the first UE or the one or more second UEs may be in a radio resource control (RRC) inactive mode.

Some examples of the method, first UEs, and non-transitory computer-readable medium described herein may further include operations, features, means, or instructions for determining to transmit the cell measurement-related information based on a battery level of the first UE, a connection state of the UE, a capability of the UE, or any combination thereof.

Some examples of the method, first UEs, and non-transitory computer-readable medium described herein may further include operations, features, means, or instructions for transmitting the cell measurement-related information to the one or more second UEs may be based on the first UE satisfying a policy defined by the network entity.

Some examples of the method, first UEs, and non-transitory computer-readable medium described herein may further include operations, features, means, or instructions for transmitting, via the cell measurement-related information, capability information associated with the first UE, the capability information including one or more supported frequency bands, a power capability, an antenna configuration, or any combination thereof.

Some examples of the method, first UEs, and non-transitory computer-readable medium described herein may further include operations, features, means, or instructions for transmitting, via the cell measurement-related information, first information associated with performing the first cell search operation, the first information indicative of one or more searched frequency ranges, one or more searched cell identifiers, or both, where the second cell search operation may be simplified based on transmitting the first information.

Some examples of the method, first UEs, and non-transitory computer-readable medium described herein may further include operations, features, means, or instructions for transmitting, via the cell measurement-related information, an indication of one or more frequency ranges, one or more cells, one or more beams, or any combination thereof for which the one or more second UEs may be to deprioritize search operations, where the second cell search operation may be simplified based on transmitting the indication.

In some examples of the method, first UEs, and non-transitory computer-readable medium described herein, the cell measurement-related information may be associated with a first subset of SSBs of a set of multiple SSBs associated with the first cell and the method, apparatuses, and non-transitory computer-readable medium may include further operations, features, means, or instructions for receiving, from one of the one or more second UEs, second information associated with a second subset of SSBs of the set of multiple SSBs different than the first subset of SSBs.

In some examples of the method, first UEs, and non-transitory computer-readable medium described herein, the cell measurement-related information may be associated with a first portion of system information associated with the first cell and the method, apparatuses, and non-transitory computer-readable medium may include further operations, features, means, or instructions for receiving, from one of the one or more second UEs, second information associated with a second portion of the system information associated with the first cell different than the first portion. In some examples, the first UE and the one or more second UEs are not associated with a UE to network (U2N) relay framework.

A method for wireless communications by a second UE is described. The method may include receiving, from a first UE of a set of UEs, cell measurement-related information that facilitates selecting a first cell associated with a network entity, where the first UE and the second UE are included in the set of UEs based on the first UE and the second UE being within a threshold distance of each other and establishing a connection with the network entity in accordance with the cell measurement-related information received from the first UE.

A second UE for wireless communications is described. The second UE may include one or more memories storing processor executable code, and one or more processors coupled with the one or more memories. The one or more processors may individually or collectively be operable to execute the code to cause the second UE to receive, from a first UE of a set of UEs, cell measurement-related information that facilitates selecting a first cell associated with a network entity, where the first UE and the second UE are included in the set of UEs based on the first UE and the second UE being within a threshold distance of each other and establish a connection with the network entity in accordance with the cell measurement-related information received from the first UE.

Another second UE for wireless communications is described. The second UE may include means for receiving, from a first UE of a set of UEs, cell measurement-related information that facilitates selecting a first cell associated with a network entity, where the first UE and the second UE are included in the set of UEs based on the first UE and the second UE being within a threshold distance of each other and means for establishing a connection with the network entity in accordance with the cell measurement-related information received from the first UE.

A non-transitory computer-readable medium storing code for wireless communications is described. The code may include instructions executable by one or more processors to receive, from a first UE of a set of UEs, cell measurement-related information that facilitates selecting a first cell associated with a network entity, where the first UE and the second UE are included in the set of UEs based on the first UE and the second UE being within a threshold distance of each other and establish a connection with the network entity in accordance with the cell measurement-related information received from the first UE.

Some examples of the method, second UEs, and non-transitory computer-readable medium described herein may further include operations, features, means, or instructions for receiving system information that facilitates selecting the first cell, where establishing the connection with the network entity may be further in accordance with the system information.

Some examples of the method, second UEs, and non-transitory computer-readable medium described herein may further include operations, features, means, or instructions for transmitting, to the first UE, a request for the system information, where receiving the system information may be based on transmitting the request.

In some examples of the method, second UEs, and non-transitory computer-readable medium described herein, the received cell measurement-related information includes cell measurement configuration information associated with the first cell, cell measurement result information associated with the first cell, first information associated with one or more synchronization signals of the first cell, second information associated with a reference signal of the first cell, or any combination thereof.

In some examples of the method, second UEs, and non-transitory computer-readable medium described herein, establishing the connection may include operations, features, means, or instructions for applying one or more first offsets to the cell measurement-related information received from the first UE, the one or more first offsets including a time offset, a frequency offset, a range-based offset, a SSB index offset, or any combination thereof.

In some examples of the method, second UEs, and non-transitory computer-readable medium described herein, establishing the connection may include operations, features, means, or instructions for utilizing, as part of a cell selection operation, a same SSB index as an SSB index included in the received cell measurement-related information to establish the connection.

In some examples of the method, second UEs, and non-transitory computer-readable medium described herein, establishing the connection may include operations, features, means, or instructions for evaluating, as part of a cell selection operation, a subset of SSBs of a set of multiple SSBs associated with the first cell, the subset of SSBs based on an SSB index included in the received cell measurement-related information.

In some examples of the method, second UEs, and non-transitory computer-readable medium described herein, the cell measurement-related information further facilitates selecting one or more second cells different than the first cell, the cell measurement-related information including priority information associated with the first cell and the one or more second cells, frequency information associated with the first cell and the one or more second cells, or any combination thereof.

Some examples of the method, second UEs, and non-transitory computer-readable medium described herein may further include operations, features, means, or instructions for selecting a second cell of the one or more second cells based on receiving the cell measurement-related information.

In some examples of the method, second UEs, and non-transitory computer-readable medium described herein, the cell measurement-related information may be further indicative of a search window for SSBs, a list of second cells that may be detectable by the first UE, a power change of a second cell, a list of second cells that may be not to be considered for cell reselection, or any combination thereof.

In some examples of the method, second UEs, and non-transitory computer-readable medium described herein, receiving the cell measurement-related information may include operations, features, means, or instructions for receiving the cell measurement-related information via a broadcast channel, a sidelink channel, a WLAN, a Bluetooth link, or any combination thereof.

In some examples of the method, second UEs, and non-transitory computer-readable medium described herein, the threshold distance may be associated with a beam of the network entity, the first UE and the second UE being located within the beam.

In some examples of the method, second UEs, and non-transitory computer-readable medium described herein, the threshold distance may be associated with a cell of the network entity, the first UE and the second UE being located within the cell.

In some examples of the method, second UEs, and non-transitory computer-readable medium described herein, the first UE or the second UE may be in an RRC inactive mode.

Some examples of the method, second UEs, and non-transitory computer-readable medium described herein may further include operations, features, means, or instructions for transmitting the cell measurement-related information to one or more third UEs based on receiving the cell measurement-related information, where the second UE and the one or more third UEs may be within a second threshold distance of each other.

Some examples of the method, second UEs, and non-transitory computer-readable medium described herein may further include operations, features, means, or instructions for establishing the connection in accordance with the received cell measurement-related information may be based on the second UE satisfying a policy defined by the network entity.

Some examples of the method, second UEs, and non-transitory computer-readable medium described herein may further include operations, features, means, or instructions for receiving, via the cell measurement-related information, capability information associated with the first UE, the capability information including one or more supported frequency bands, a power capability, an antenna configuration, or any combination thereof.

Some examples of the method, second UEs, and non-transitory computer-readable medium described herein may further include operations, features, means, or instructions for receiving, via the cell measurement-related information, first information associated with one or more searching operations performed by the first UE, the first information including one or more searched frequency ranges, one or more searched cell identifiers, or both.

Some examples of the method, second UEs, and non-transitory computer-readable medium described herein may further include operations, features, means, or instructions for receiving, via the cell measurement-related information, an indication of one or more frequency ranges, one or more cells, one or more beams, or any combination thereof for which the second UE may be to deprioritize search operations.

In some examples of the method, second UEs, and non-transitory computer-readable medium described herein, the cell measurement-related information may be associated with a first subset of SSBs of a set of multiple SSBs associated with the first cell and the method, apparatuses, and non-transitory computer-readable medium may include further operations, features, means, or instructions for obtaining second information associated with a second subset of SSBs of the set of multiple SSBs different than the first subset of SSBs and transmitting the second information to the first UE, one or more third UEs, or both.

In some examples of the method, second UEs, and non-transitory computer-readable medium described herein, the cell measurement-related information may be associated with a first portion of system information associated with the first cell and the method, apparatuses, and non-transitory computer-readable medium may include further operations, features, means, or instructions for obtaining a second portion of the system information associated with the first cell different than the first portion and transmitting second information including the second portion of the system information to the first UE, one or more third UEs, or both.

A method for wireless communications by a network entity is described. The method may include outputting, to a first UE, cell measurement-related information that facilitates selection of a cell associated with the network entity, where the network entity is configured to communicate with a set of UEs including the first UE and one or more second UEs, and where the first UE and the one or more second UEs are included in the set of UEs based on the first UE and the one or more second UEs being within a threshold distance of each other and establishing a connection with the one or more second UEs based on outputting the cell measurement-related information to the first UE.

A network entity for wireless communications is described. The network entity may include one or more memories storing processor executable code, and one or more processors coupled with the one or more memories. The one or more processors may individually or collectively be operable to execute the code to cause the network entity to output, to a first UE, cell measurement-related information that facilitates selection of a cell associated with the network entity, where the network entity is configured to communicate with a set of UEs including the first UE and one or more second UEs, and where the first UE and the one or more second UEs are included in the set of UEs based on the first UE and the one or more second UEs being within a threshold distance of each other and establish a connection with the one or more second UEs based on outputting the cell measurement-related information to the first UE.

Another network entity for wireless communications is described. The network entity may include means for outputting, to a first UE, cell measurement-related information that facilitates selection of a cell associated with the network entity, where the network entity is configured to communicate with a set of UEs including the first UE and one or more second UEs, and where the first UE and the one or more second UEs are included in the set of UEs based on the first UE and the one or more second UEs being within a threshold distance of each other and means for establishing a connection with the one or more second UEs based on outputting the cell measurement-related information to the first UE.

A non-transitory computer-readable medium storing code for wireless communications is described. The code may include instructions executable by one or more processors to output, to a first UE, cell measurement-related information that facilitates selection of a cell associated with the network entity, where the network entity is configured to communicate with a set of UEs including the first UE and one or more second UEs, and where the first UE and the one or more second UEs are included in the set of UEs based on the first UE and the one or more second UEs being within a threshold distance of each other and establish a connection with the one or more second UEs based on outputting the cell measurement-related information to the first UE.

Some examples of the method, network entities, and non-transitory computer-readable medium described herein may further include operations, features, means, or instructions for refraining from outputting the cell measurement-related information to the one or more second UEs, where establishing the connection with the one or more second UEs may be based on the refraining.

In some examples of the method, network entities, and non-transitory computer-readable medium described herein, the cell measurement-related information includes cell measurement configuration information.

In some examples of the method, network entities, and non-transitory computer-readable medium described herein, the cell measurement configuration information includes a policy defined by the network entity, the policy identifying one or more conditions that may be to be satisfied by the first UE and establishing the connection may be based on the policy.

Some examples of the method, network entities, and non-transitory computer-readable medium described herein may further include operations, features, means, or instructions for outputting, to the first UE, system information that facilitates selection of the cell, where establishing the connection with the one or more second UEs based on outputting the system information.

Some examples of the method, network entities, and non-transitory computer-readable medium described herein may further include operations, features, means, or instructions for refraining from outputting the system information to the one or more second UEs, where establishing the connection with the one or more second UEs may be based on the refraining.

In some examples of the method, network entities, and non-transitory computer-readable medium described herein, outputting the system information may include operations, features, means, or instructions for outputting the system information during a connection establishment operation with the first UE or outputting the system information based on a network configuration change at the network entity.

Some examples of the method, network entities, and non-transitory computer-readable medium described herein may further include operations, features, means, or instructions for receiving, from the first UE, a request for the system information, where outputting the system information may be based on receiving the request.

Some examples of the method, network entities, and non-transitory computer-readable medium described herein may further include operations, features, means, or instructions for establishing a second connection with the first UE based on outputting the cell measurement-related information to the first UE.

In some examples of the method, network entities, and non-transitory computer-readable medium described herein, outputting the cell measurement-related information may include operations, features, means, or instructions for outputting one or more SIBs associated with the cell that include first information associated with one or more second cells different than the cell, the cell measurement-related information including the first information.

In some examples of the method, network entities, and non-transitory computer-readable medium described herein, the first information includes priority information associated with the one or more second cells, frequency information associated with the one or more second cells, or both.

A computer program product for wireless communications by a first UE is described. The computer program product includes instructions that are executable by a computer. The instructions may include performing a first cell search operation to initiate selection of a first cell associated with a network entity, obtaining cell measurement-related information that facilitates performance, by one or more second UEs of a set of UEs, of a second cell search operation to initiate selection of the first cell based on performing the first cell search operation, where the second cell search operation is simplified with respect to the first cell search operation, and transmitting the cell measurement-related information to the one or more second UEs of the set of UEs based on obtaining the cell measurement-related information, where the first UE and the one or more second UEs are included in the set of UEs based on the first UE and the one or more second UEs being within a threshold distance of each other.

A computer program product for wireless communications by a second UE is described. The computer program product includes instructions that are executable by a computer. The instructions may include receiving, from a first UE of a set of UEs, cell measurement-related information that facilitates selecting a first cell associated with a network entity, where the first UE and the second UE are included in the set of UEs based on the first UE and the second UE being within a threshold distance of each other and establishing a connection with the network entity in accordance with the cell measurement-related information received from the first UE.

A computer program product for wireless communications by a network entity is described. The computer program product includes instructions that are executable by a computer. The instructions may include outputting, to a first UE, cell measurement-related information that facilitates selection of a cell associated with the network entity, where the network entity is configured to communicate with a set of UEs including the first UE and one or more second UEs, and where the first UE and the one or more second UEs are included in the set of UEs based on the first UE and the one or more second UEs being within a threshold distance of each other and establishing a connection with the one or more second UEs based on outputting the cell measurement-related information to the first UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for user equipment (UE) assisted cell selection in accordance with one or more aspects of the present disclosure.

FIG. 2 shows an example of a wireless communications system that supports techniques for UE assisted cell selection in accordance with one or more aspects of the present disclosure.

FIG. 3 shows an example of a process flow that supports techniques for UE assisted cell selection in accordance with one or more aspects of the present disclosure.

FIGS. 4 and 5 show block diagrams of devices that support techniques for UE assisted cell selection in accordance with one or more aspects of the present disclosure.

FIG. 6 shows a block diagram of a communications manager that supports techniques for UE assisted cell selection in accordance with one or more aspects of the present disclosure.

FIG. 7 shows a diagram of a system including a device that supports techniques for UE assisted cell selection in accordance with one or more aspects of the present disclosure.

FIGS. 8 and 9 show block diagrams of devices that support techniques for UE assisted cell selection in accordance with one or more aspects of the present disclosure.

FIG. 10 shows a block diagram of a communications manager that supports techniques for UE assisted cell selection in accordance with one or more aspects of the present disclosure.

FIG. 11 shows a diagram of a system including a device that supports techniques for UE assisted cell selection in accordance with one or more aspects of the present disclosure.

FIGS. 12 through 16 show flowcharts illustrating methods that support techniques for UE assisted cell selection in accordance with one or more aspects of the present disclosure.

### DETAILED DESCRIPTION

In some wireless communication systems, a user equipment (UE) may perform various operations to establish a connection with (e.g., access) a cell of a network entity. For instance, a UE may perform one or more operations such as cell search operations (e.g., blind searching across various parameters including time resources, frequency resources, spatial resources, cell identifiers), cell selection operations, cell reselection operations, system information acquisition, or other operations to obtain (e.g., receive, acquire, detect) information that facilitates connection with the cell. In some cases, each UE that connects to the cell may perform a same set of operations to establish their respective connections, and at least some UEs may be located relatively close together (e.g., within a threshold distance of each other).

In some cases, each of the UEs (e.g., closely-located UEs) may obtain the same (or substantially similar) results after performing such cell selection operations (e.g., based on being associated with a same geographic area and/or with similar network conditions). For instance, nearby UEs may obtain a same set of measurement results (e.g., synchronization signal block (SSB) search results, SSB measurement results) for connecting with the cell and/or a same set of system information (e.g., may decode one or more same system information blocks (SIBs)). Thus, performance of the cell searching operations (e.g., or other related operations) by each of the UEs may be relatively redundant and result in excessive resource consumption, increased signaling overhead, and other inefficiencies in a wireless communications system.

In accordance with one or more techniques described herein, a UE may be configured to transmit (e.g., share, convey, broadcast, output) cell selection information (e.g., cell measurement-related information, system information, cell reselection information) to one or more other UEs (e.g., other UEs located within a threshold distance or associated with a same group). The cell selection information may facilitate one or more cell selection (e.g., or cell reselection) operations by the other UEs (e.g., a simplified cell selection operation, a reduced cell selection operation). For example, a first UE (e.g., an “assisting” UE) may perform a first search operation and may obtain some information associated with cell selection (e.g., as part of the cell search operation, as part of a connection establishment).

The first UE may transmit the obtained information to one or more second UEs (e.g., “assisted” UEs) that are located within a threshold distance of (e.g., collocated with) the first UE. For instance, after the first UE has successfully selected a cell, the first UE may share information used to establish a connection with the cell. Accordingly, each of the second UEs may use the shared information to simplify their own cell search operations (e.g., by leveraging the search results, or other information, provided by the first UE), which may reduce redundant resource consumption (e.g., side processing, UE side processing) by the second UEs. Thus, by sharing cell selection information among a group of collocated UEs, a wireless communication system may support reduced power consumption, reduced signaling overhead, improved response times, and other benefits.

Aspects of the disclosure are initially described in the context of wireless communications systems. Aspects of the disclosure are further illustrated by and described with reference to process flows, apparatus diagrams, system diagrams, and flowcharts that relate to techniques for UE assisted cell selection.

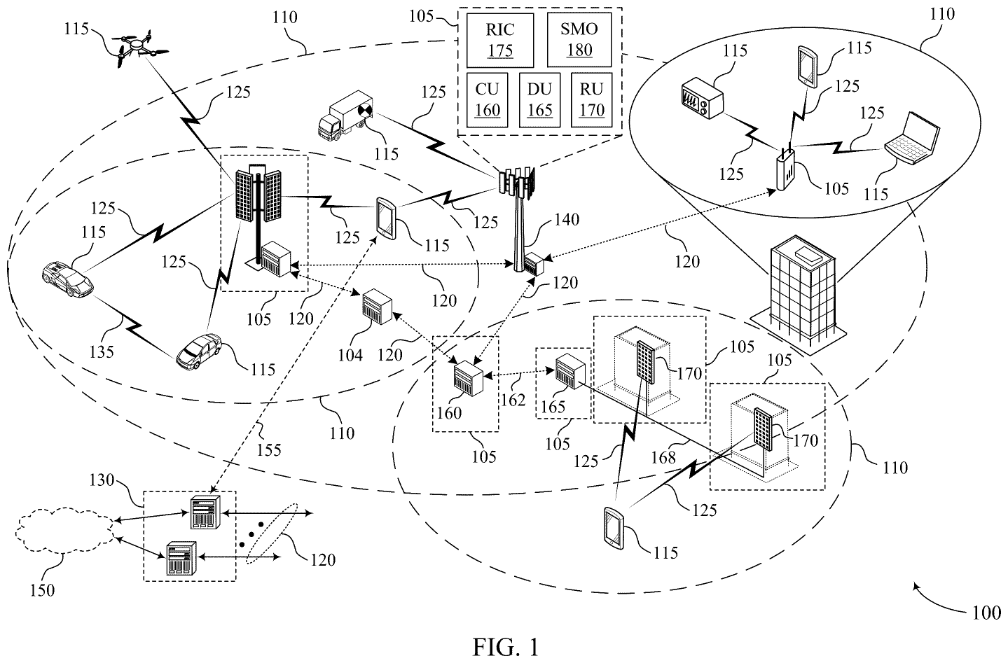

FIG. 1 shows an example of a wireless communications system 100 that supports techniques for UE assisted cell selection in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In accordance with aspects of the present disclosure, a UE 115 may be configured to transmit (e.g., share, convey, broadcast, output) cell selection information (e.g., cell measurement-related information, system information, cell reselection information) to one or more other UEs (e.g., one or more UEs 115 located within a threshold distance or associated with a same group). The cell selection information may facilitate one or more cell selection (e.g., and/or cell reselection) operations by the other UEs (e.g., a simplified cell selection operation, a reduced cell selection operation). For example, a first UE 115 may perform a first search operation and may obtain some information associated with cell selection and/or cell reselection. The first UE 115 may transmit the obtained information to one or more second UEs 115, which may be located within a threshold distance of the first UE (e.g., located within a same spatial beam, located within a same coverage area 110). For instance, after the first UE 115 has successfully selected a cell, the first UE 115 may share information that it used to establish a connection with the cell (e.g., with a network entity 105 associated with the cell). Accordingly, each of the second UEs 115 may use the shared information to simplify their own one or more cell search operations (e.g., cell selection. cell reselection, system information acquisition), thus reducing redundant resource consumption. Accordingly, by applying one or more techniques described herein, a wireless communications system 100 may support reduced power consumption, reduced signaling overhead, improved response times, and other benefits.

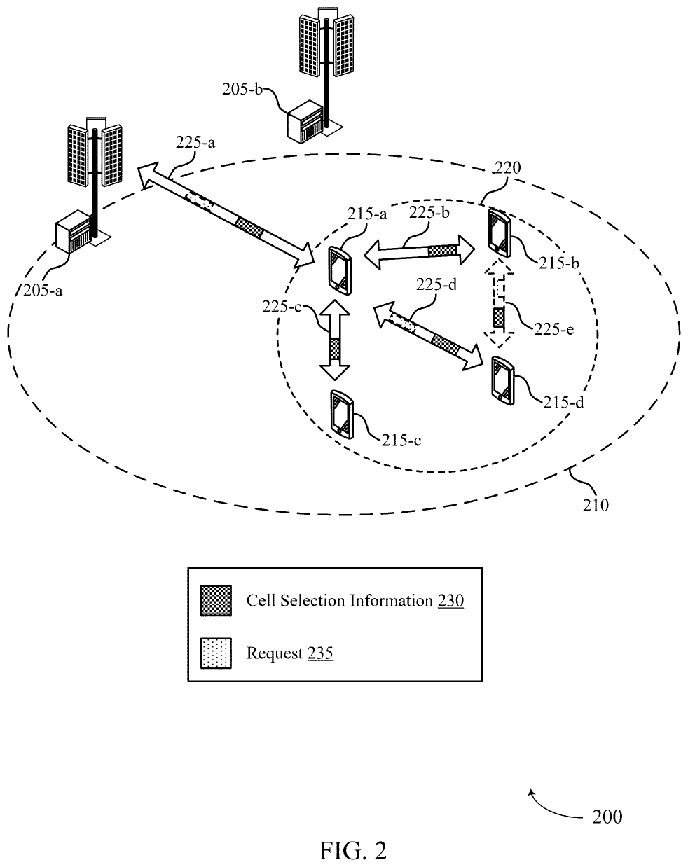

FIG. 2 shows an example of a wireless communications system 200 that supports techniques for UE assisted cell selection in accordance with one or more aspects of the present disclosure. The wireless communications system 200 may implement or be implemented by aspects of the wireless communications system 100 as described with reference to FIG. 1. For example, the wireless communications system 200 may include a UE 215-a, a UE 215-b, a UE 215-c, a UE 215-d, a network entity 205-a, and a network entity 205-b, which may represent examples of corresponding devices described herein, including with reference to FIG. 1 (e.g., UEs 115, network entities 105).

The UEs 215 and the network entities 205 may communicate with each other via respective communication links 225 (e.g., links 125 as shown in FIG. 1, communication link 225-a, communication link 225-b, communication link 225-c, communication link 225-d, communication link 225-e) and may exchange signaling (e.g., cell selection information 230, a request 235, or other signaling) to support the one or more techniques described herein. The network entity 205-a may be associated with a cell or a coverage area 210 (e.g., a first cell, a coverage area 110), which may be accessed (e.g., selected) by the UEs 215. The network entity 205-b may also be associated with a coverage area (not shown), which may at least partially overlap with the coverage area 210 or may not overlap with the coverage area 210. Although, the techniques herein are described with reference to network entities 205 and UEs 215, the same or similar techniques may be applied other wireless devices (e.g., including as described with reference to FIG. 1).

In some systems, a UE 215 may support one or more procedures (e.g., in a radio resource control (RRC) idle state or RRC inactive state) such as cell selection, cell reselection, system information acquisition, paging message communication, and radio access network (RAN) area registration in order to select and connect with a cell (e.g., of a network entity 205). Such procedures may be performed by each UE 215 to establish respective connections with the cell and the corresponding network entity 205. For instance, during initial cell selection (e.g., and/or cell reselection) each UE 215 may search (e.g., blindly, without any previously obtained information) across time resources (e.g., slots, symbols), frequency resources (e.g., synchronization rasters, frequency resource blocks), spatial resources (e.g., beams, transmission configuration indicator (TCI) states), cell identifiers (IDs), or other parameters, and each UE 215 may be expected to perform their own respective operations for procedures such as cell search and system information acquisition.

A system information acquisition procedure performed by a UE 215 may include a series of operations. As an illustrative example, in a first operation, the UE 215 may power on. In a second operation, the UE 215 may decode a primary synchronization signal (PSS) and a secondary synchronization signal (SSS) (e.g., UE frequency and time synchronization) and may calculate a physical cell ID (PCI). In a third operation, the UE 215 may decode a physical broadcast channel (PBCH) demodulation reference signal (DMRS). In a fourth operation, the UE 215 may further decode the PBCH to acquire a master information block (MIB) (e.g., UE reads minimum system information, which may include subcarrier spacing (SCS) for system information blocks (SIBs), physical downlink control channel (PDCCH) configuration for SIB1, indication if cell is barred). In a fifth operation, the UE 215 may determine whether the cell (e.g., the detected cell) is barred. If the cell is barred, the UE 215 may attempt to acquire another cell and return to perform the second operation. If the cell is not barred, the UE 215 may continue to a sixth operation. In the sixth operation, the UE 215 may perform PDCCH decoding (e.g., decode a location of SIB1). In a seventh operation, the UE 215 may perform PDSCH decoding for SIB1 (e.g., including decoding a location of SIB1 for public land mobile network (PLMN) ID, cell selection parameters, random access channel (RACH) parameters). In an eighth operation, the UE 215 may determine whether a PLMN matches. If the PLMN does not match, the UE 215 may attempt to acquire another cell and return to perform the second operation. If the PLMN does match, the UE 215 may proceed to a ninth operation. In the ninth operation, the UE 215 may determine whether cell selection is successful. If the cell selection is not successful, the UE 215 may attempt to acquire another cell and return to perform the second operation. If the cell selection is successful, the UE 215 may be ready for a RACH (e.g., initial access) procedure.

In some cases, the UEs 215 may also support a relay communication framework (e.g., a layer 2 (L2) U2N framework) in which a relay UE 215 may help a remote UE 215 acquire or re-acquire relevant system information when system information changes. For instance, the system information may be forwarded to a U2N remote UE in a unicast manner (e.g., one relay UE helping one remote UE). For instance, a U2N Relay UE (e.g., a UE 215-a) may assist a U2N Remote UE (e.g., a UE 215-d) by providing system information, forwarding broadcast and/or multicast messages received from the cell, and managing resources (e.g., higher-layer signaling information used for network access and connectivity). To establish this assistance, the U2N Relay UE may perform a full set of evaluation and configuration operations. Subsequently, communications may be unicast between one U2N Relay UE and one U2N Remote UE. In some cases, a U2N relay framework may assume specific L1 and L2 technology between UEs 215.

In accordance with one or more aspects described herein, the various devices of a wireless communications system 200 may support UE-assisted access techniques to improve efficiency and reduce resource consumption (e.g., improve power savings). For example, access procedures performed by an idle UE or an inactive UEs (e.g., UE 215-b, UE 215-c, UE 215-d) may be assisted by one or more other UEs 215 (e.g., a UE 215-a, which may be in an idle state or a connected state). In some examples, the assistance may be based on a first UE 215 (e.g., or multiple UEs 215) obtaining cell selection information 230 (e.g., cell measurement-related information, cell measurement configuration information, cell measurement result information, system information, cell reselection information, or other information) and sharing (e.g., transmitting, outputting, broadcasting, sending) the cell selection information 230 to other UEs 215. Such UEs may be associated with a group 220 of UEs 215 (e.g., a cooperation group, a collaboration group), which may include UEs 215 that are located within a threshold distance of each other. Such techniques may reduce UE side processing, optimize UE power consumption, and increase network efficiency. In some examples, the UE-assisted techniques (and other techniques described herein) may be independent of the U2N framework and U2N technology between UEs 215. Alternatively, in some examples, a reduced U2N relay framework may be leveraged, and may focus on efficient assistance.

The wireless communications system 200 may support various UE collaboration scenarios. For example, a group 220 (e.g., a UE cooperation group) may include (e.g., be formed of) one or more UEs 215 that are collocated (e.g., located with a threshold distance) or moving together. In some examples, UEs 215 of the group 220 may belong to a same PLMN or to different PLMNs. In some examples, “collocated” or “collocation” may refer to different spatial scenarios based on an application (e.g., based on the use-case). For instance, in one example multiple UEs 215 (e.g., the group 220) may be collocated at a beam level (e.g., located relatively close to each other, located within a threshold beam angle) and in another example multiple UEs may be collocated at a cell level (e.g., located in different neighboring beams, located outside a threshold beam angle). That is, UEs 215 in collaboration may be (e.g., geographically) relatively close to each other (e.g., the threshold distance may be relatively smaller), or the UEs may be relatively far apart (e.g., the threshold distance may be relatively larger) and may still be within range of communication with each other.

As an illustrative example, such cooperative UEs 215 (e.g., or other devices) within a group 220 may be associated with a same user (e.g., or a same household of users). In some examples, the UEs 215 of the group 220 may support UE-to-UE communications via respective communication links 225, which may respectively represent an example of or include a sidelink communication link, a Bluetooth communication link, a Wi-Fi communication link, or a combination thereof. For example, the UEs 215 may be connected with a same router (e.g., an access point, in a Wi-Fi network, in a wireless local area network (WLAN)). A UE 215 may obtain information, may transmit (e.g., route, output, convey) the information to a router (e.g., an access point, which may not have a connection with a cell of a network entity 205) and the router may forward the information to one or more other UEs 215 of the group 220.

In some examples, the UEs 215 of the group 220 may be respectively associated with a connection status (e.g., an RRC status). For example, each of the UEs 215 may be in an idle mode or inactive mode (e.g., RRC inactive/idle mode). Alternatively, one or more UEs 215 of the group 220 may be in a connected mode (e.g., RRC connected mode), while one or more other UEs 215 may be in the idle mode or inactive mode. Example scenarios of a group 220 of UEs may include the UEs 215 (e.g., or other devices) returning to a coverage area 210 from an out-of-coverage area (e.g., based on disabling an airplane mode or exiting a tunnel), UEs 215 that are located in a same location (e.g., such as in an office, in a vehicle, or in a home) where system information has changed (e.g., via an indication) or where a UE 215 does not have valid system information, and UEs 215 that are located in a moving vehicle (e.g., and undergoing cell reselection).

In some examples, one or more UEs 215 of the group 220 may be selected (e.g., delegated, determined, identified, designated, chosen) to obtain cell selection information 230 (e.g., to initially perform a full cell selection procedure, a full cell reselection procedure, a full system information acquisition procedures) and to transmit the cell selection information 230 to one or more other UEs 215. The selected one or more UE(s) 215 may be referred to as “assisting UEs” or “delegate UEs.” In some examples, an assisting UE 215 (e.g., a delegate UE) may be selected based on various criteria such as a UE battery power level, a connection state of the UE (e.g., RRC status, RRC connected status), a capability of the UE, other criteria, or a combination thereof. The one or more UEs 215 that received the obtained cell selection information 230 may be referred to as “assisted UEs.”

In some implementations, the assistance techniques may be based on UE-assisted SSB search and measurement. For example, a UE 215-a (e.g., a connected UE 215, a delegate UE 215, an assisting UE 215) may facilitate access of other UEs 215 (e.g., assisted UEs) of the group 220 to a cell (e.g., of the network entity 205-a) by sharing SSB search information and corresponding measurement information obtained during an initial cell selection operation (e.g., a full cell selection procedure). That is, the UE 215-a may perform a blind search across various parameters during cell selection (e.g., may perform SSB beam sweeping). Such parameters may include time resource parameters, frequency resource parameters (e.g., synchronization rasters), spatial resource parameters (e.g., beams, TCI states), and PCI parameters (e.g., cell IDs), among other examples. The UE 215-a may further (and individually) obtain other information such as the MIB and other system information during this search.

In some examples, during one or more cell search operations, the UE 215-a (e.g., and/or other assisting UEs 215) may scan synchronization rasters (e.g., perform frequency tuning) to find a PSS and an SSS (e.g., perform PSS and SSS decoding) and obtain a PCI associated with a cell. The UE 215-a may then find the PBCH DMRS (e.g., perform PBCH decoding) and may synchronize with the cell with respect to time resources and frequency resources (e.g., and cell search may be considered completed at this stage). Subsequently, the UE 215-a may read a MIB, obtain SCS information (e.g., a common SCS), and obtain a PDCCH configuration (e.g., for SIB1). The UE 215-a may then utilize the obtained information to obtain system information (e.g., SIB1, remaining minimum system information (RMSI), other system information (OSI)).

The UE 215-a (e.g., an assisting UE 215 in any state) may facilitate the access of other UEs 215 in the group 220 (e.g., idle or inactive UEs, UEs 215 in assisted mode) to the cell of the network entity 205-a. The UE 215-a may share cell selection information 230 that includes SSB search and SSB measurement information that it obtained during one or more cell search operations. Accordingly, the UEs 215 that receive the cell selection information 230 may perform a simplified cell search operation. In other words, rather than conducting a full cell search operation themselves, the assisted UEs 215 may perform a simplified or reduced set search (e.g., by omitting one or more operations of a cell search) based on utilizing the shared cell selection information 230 (e.g., the shared SSB search information and SSB measurement results). As a result, a burden of acquiring and evaluating SSB-related information at the assisted UEs 215 may be reduced. Such techniques may be associated with reduced signaling overhead based on assisting UEs 215 transmission of cell selection information 230 (e.g., and other relevant information), thus mitigating redundant search operations. Further the techniques may enable simplified communication based on assisted UEs 215 leveraging the information shared by the assisting UE 215, thereby streamlining their own cell selection processes.

The assisted UEs 215 (e.g., the UE 215-b, the UE 215-c, the UE 215-d) may leverage the cell selection information 230 to simplify their cell selection operation(s) in accordance with various techniques. In some examples, the assisted UEs 215 may respectively determine a time offset and/or a frequency offset between themselves and an assisting UE (e.g., UE 215-a), which may be based on some synchronization signals exchanged between them. Using the one or more offsets, the assisted UEs 215 may calculate their respective time resources and frequency resources relative to cell (e.g., of the network entity 205-a). That is, the assisted UEs 215 may combine the time information and frequency information (e.g., included in the cell selection information 230) acquired and shared by the assisting UE 215 with their respective offset(s).

Additionally, or alternatively, if the assisted UEs 215 do not have sufficient time and/or frequency offset information, the UEs 215 may determine a range of potential offset(s) within which their respective offset(s) may be included. Accordingly, the assisted UEs 215 may reduce their respective search range for time resource and frequency resource acquisition using the cell selection information 230 shared by the assisting UE 215. In some examples, the shared cell selection information 230 may include synchronization signal information (e.g., SSref, other reference signals), synchronization raster information, global synchronization channel number (GSCN) information, new radio absolute radio frequency channel (NR-ARFCH) information, channel bandwidth information, channel raster information, SS raster information, SS block and/or PBCH block information (e.g., subcarrier information), or any combination thereof.

Additionally, or alternatively, the assisted UEs 215 may use a same SSB beam index (e.g., a same spatial direction) as shared by the assisting UE 215 (e.g., included in the cell selection information 230, when the group 220 are closely collocated within a same beam coverage area). In some examples, the assisted UEs 215 may not use a same SSB beam index as the assisting UE 215. Instead, the assisted UEs 215 may use a reduced beam search set (e.g., with a reduced quantity of SSB candidates, by searching one or more neighboring SSB indexes). The reduced search set may include neighboring beams of the SSB acquired by the assisting UE 215. Such examples may be applicable when the assisted UEs 215 are not closely collocated with the assisting UE 215. Thus, by leveraging such collaborative approaches, UEs 215 may enhance their initial cell selection process, reduce redundant searches, and improve overall energy efficiency in the wireless communications system 200.

In some examples, the cell selection information 230 may also be associated with cell reselection information (e.g., information associate a different cell of the network entity 205-a or of another network entity 205-b). That is, one or more assisting UEs 215 (e.g., UE 215-a, a connected UE) may facilitate cell reselection for other assisted UEs (e.g., idle or inactive UEs 215, UE 215-b through UE 215-d). For example, a UE 215 may acquire information from multiple SIBs (e.g., SIB1, SIB2, SIB3, SIB4) of a currently camped cell to initiate cell reselection. Such information may include details about neighboring cells (e.g., cells associated with a network entity 205-b), a signal strength of the neighboring cells, and other relevant parameters (e.g., cell reselection parameters). In some examples, an assisting UE 215 may share (e.g., via the cell selection information 230) obtained system information (e.g., associated with any of SIB2-4) with the assisted UEs 215. Such sharing may occur with or without including an indication of a cell reselection decision by the assisting UE 215. Additionally, or alternatively, the assisting UE may provide other information (e.g., finer details that are not present in SIB2-4) such as a relatively smaller (or reduced) search window (e.g., a refined search window) for SSBs, information pertaining to potential (e.g., suitable) neighboring cells, an indication of cell power changes, a list of detectable cells, a list of barred (e.g., blacklisted) cells (e.g., cells to be avoided) in an area where the group 220 of UEs 215 are located. Thus, the UEs 215 may support enhanced decision making by leveraging the cell selection information 230, enabling the UEs 215 to make more informed cell reselection decisions.

The UEs 215 may leverage the cell reselection information in accordance with various techniques. In some examples, an assisting UE may obtain (e.g., acquire) reselection priority information (e.g., carried in system information or RRC connection release message) and may share the reselection priority information with the assisted UEs. Accordingly, assisted UEs 215 may use such information to evaluate and prioritize cell reselection operations. Additionally, or alternatively, the assisting UE 215 may acquire information (e.g., via system information) related to evolved universal terrestrial radio access network (E-UTRAN) frequencies and inter radio access technology (RAT) frequencies. The assisting UE 215 may share such information (e.g., via the cell selection information 230) with the assisted UEs 215, and the assisted UEs 215 may use the information to perform cell reselection evaluations (e.g., considering available frequencies). Thus, by sharing such information, assisted UEs 215 may optimize their respective cell reselection decisions, reduce redundant searches, and improve overall energy efficiency.

In some examples, the cell selection information 230 may be associated with system information acquisition. That is, one or more assisting UEs 215 may forward obtained (e.g., acquired) system information to one or more assisted UEs 215. The assisting UE 215 may share the system information after acquisition, which may occur during a connection establishment stage or when the network (e.g., or parameters thereof) changes. Such techniques may support enhancements over other technologies (e.g., U2N relay framework). For example, an assisting UE 215 may broadcast (e.g., actively advertise, without a request) the system information they have obtained (e.g., acquired, stored) to each of the other UEs 215 in the group 220. Additionally, or alternatively, the assisted UEs 215 (e.g., UE 215-b, UE 215-c, UE 215-d) may transmit one or more requests 235 for one or more portions of system information. The assisted UEs 215 may transmit (e.g., broadcast) the request(s) 235 to one or more of the UEs 215 of the group 220, and any of the UEs 215 (e.g., the assisting UE 215 or other assisted UEs 215) that have the requested system information may respond and share the relevant information (e.g., via cell selection information 230). In some examples, if the UEs 215 in the group 220 may not have the requested system information, and the assisting UE 215 (e.g., the UE 215-a) may transmit a request 235 (e.g., an on-demand system information request) to the network entity 205-a (e.g., which may reduce network signaling).

As a non-limiting example, a first UE 215 may perform a first cell search operation to initiate selection of a first cell associated with a network entity 205-a. The first UE 215 may obtain system information that facilitates the performance, by one or more second UEs 215 of a set of UEs, of a second cell search operation to initiate selection of the first cell based on performing the first cell search operation, where the second cell search operation is simplified with respect to the first cell search operation. The first UE 215 may transmit the system information to the one or more second UEs 215 of the set of UEs based on obtaining the system information.

In some examples, an assisting UE 215 (e.g., a UE 215-b) may receive the cell selection information 230 (e.g., including SSB search and SSB measurement information, cell reselection information, system information, or a combination thereof) and may transmit (e.g., forward, as part of a multi-hop operation) the received cell selection information 230 to other UEs 215 (e.g., a UE 215-d). In some examples, multi-hop operation techniques (e.g., within the group 220, in addition to broadcasting and single-hop operations) may further enhance UE collaboration and information sharing. For instance, the UE 215-b may be assisted by the UE 215-a, and the UE 215-b may also assist the UE 215-d. In some examples, the UE 215-b may share assistance information (e.g., the cell selection information 230) with the UE 215-d based on transmitting the same assistance information received from the UE 215-a or based on transmitting processed assistance information (e.g., by modifying at least a portion of the received information) received from the UE 215-a. Such techniques may enable improved efficiency in the wireless communications system 200. For example, assisting UEs 215 may not be expected to signal assistance information to all UEs 215 of the group 220, which may reduce an overall signaling burden. Additionally, a communication protocol among UEs 215 may be simplified, as UEs 215 may share assistance information with nearby UEs 215. In some examples of multi-hop communication, the UEs 215 may be located within a relatively small threshold distance (e.g., may be close to each other) and may accordingly improve overall network efficiency.

In some examples, sharing the cell selection information 230 among UEs 215 and using the information to simplify cell selection procedures (e.g., by skipping one or more steps of cell selection/reselection) may be based on a policy from the network (e.g., transmitted or indicated by the network entity 205-a via cell measurement configuration information) and a subscription with the network. In such examples, separate (e.g., different) policies may respectively apply to assisting UEs 215 and assisted UEs 215. For example, a policy may define one or more conditions that are to be satisfied in order for a UE 215 to operate as an assisting UE 215 (e.g., thereby being authorized to share the cell selection information 230) and/or an assisted UE 215. Accordingly, in some examples, establishing a connection with one or more UEs 215 may be based on the policy defined (e.g., and indicated) by the network. Additionally, or alternatively, UEs 215 may share information about their capabilities (e.g., one or more supported bands, a power level, and/or one or more antenna configurations such as an equipped multi-antenna). In some examples, the cell selection information 230 may also include information associated with a result of a search operation performed by an assisting UE 215, which may indicate which frequencies, cell IDs, and other parameters that it has already searched for. In some examples, an assisting UE 215 may also indicate for which frequencies, cells, beams, and other resources that the assisted UEs 215 may deprioritize their respective searches (e.g., or to not perform corresponding searches at all). For example, the assisting UE may transmit (e.g., provide) such an indication based on performing a search operation using such parameters and not obtaining any search results.

In some examples, multiple UEs 215 of the group 220 may work together to perform SSB measurement and system information acquisition tasks (e.g., instead of relying on a single assisting UE 215). Such UEs 215 may communicate (e.g., via handshaking) and may exchange relevant information, such as their respective capabilities and prior search results. Based on the exchanged information, the UEs 215 may determine a division of the workload. For instance, a UE 215-a may handle (e.g., measure) a specific subset of SSBs or frequencies and a UE 215-b may measure a different subset of SSBs or frequencies. Additionally, or alternatively, the UE 215-a may start from a top of a frequency search list and may continue down the list, and UE 215-b may begin from a bottom of the frequency search list and may work up the list. In some examples, each UE 215 of the group 220 may be responsible for a subset of system information acquisition. Accordingly, by dividing the responsibilities of sharing cell selection information 230, the UEs 215 may improve resource efficiency by reducing redundant searches, may achieve faster cell discovery with parallel processing, and enable adaptability (e.g., UEs 215 may adjust their search strategies based on real-time conditions), among other benefits.

In some examples, the present disclosure may enable UEs 215 to skip one or more access procedures, including initial access and cell reselection, which may reduce processing overhead and improve resource utilization. That is, a UE 215 may reduce the standard steps and may perform an alternatively set of operations as described herein. For example, a UE 215 may conduct its access procedure with partially reduced steps, using assisting information obtained from another nearby UE(s) 215. Further, a UE 215 may obtain network system information indirectly from nearby UE(s) 215 or other devices. Thus, the wireless communications system 200 may support reduced power consumption, reduced signaling overhead, and improved response times, among other benefits.

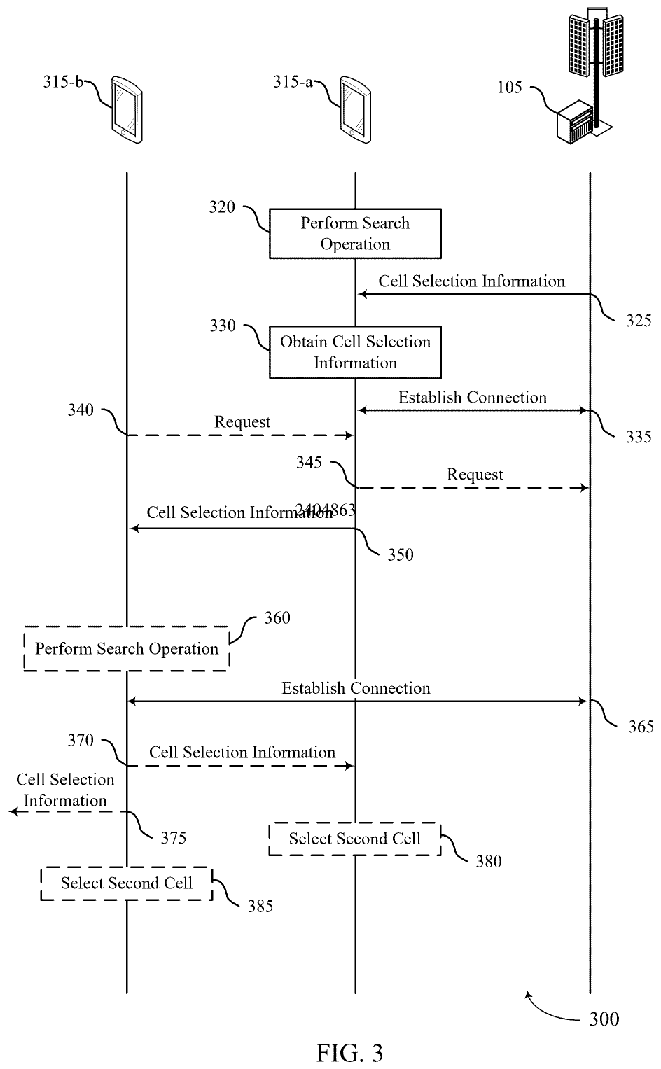

FIG. 3 shows an example of a process flow 300 that supports techniques for UE assisted cell selection in accordance with one or more aspects of the present disclosure. The process flow 300 may implement or be implemented to realize aspects of the wireless communications system 100 and the wireless communications system 200. For example, the process flow 300 may illustrate communication between a UE 315-a, a UE 315-b, and a network entity 105, which may be examples of corresponding devices described herein, including with reference to FIGS. 1 and 2 (e.g., UEs 115, UEs 215, network entities 205). Alternative examples of the following may be implemented. For example, some steps may be performed in a different order than described or may not be performed at all. In some implementations, steps may include additional features not mentioned below, or further steps may be added. Further, although the UEs 315 and the network entity 105 are shown performing the operations of the process flow 300, some aspects of some operations may also be performed by one or more other wireless communication devices.

At 320, a UE 315-a (e.g., an assisting UE, a delegate UE) may perform a first cell search operation (e.g., a full cell search, an initial cell search) to initiate selection of a first cell associated with a network entity 105.

At 325, the network entity 105 may output (e.g., transmit, send), to a UE 315-a, cell selection information (e.g., cell measurement-related information) that facilitates selection of a cell associated with the network entity 105. In some examples, the network entity 105 may be configured to communicate with a set of UEs (e.g., a group 220 of UEs 215) including the UE 315-a and one or more UEs 315-b, and the UE 315-a and the one or more UEs 315-b may be included in the set of UEs based on being within a threshold distance of each other. In some examples, the 105 may refrain from outputting the cell selection information to the one or more UEs 315-b. In some examples, the cell selection information may include cell measurement configuration information associated with a policy defined by the network entity, where the policy may identify one or more conditions that are to be satisfied by the UE 315-a.

At 330, the UE 315-a may obtain cell selection information that includes cell measurement-related information (e.g., cell selection information 230), which may facilitate performance, by one or more UEs 315-b of the set, of a second cell search operation to initiate selection of the first cell based on performing the first cell search operation. In some examples, the second cell search operation may be simplified with respect to the first cell search operation (e.g., associated with fewer searching tasks or modified searching parameters). In some examples, the cell measurement-related information may include cell measurement configuration information, cell measurement result information, cell reselection information, cell reselection measurement results, or both.

In some examples, the UE 315-a may receive one or more synchronization signals (e.g., PSS, SSS, SSB) from the network entity 105 based on performing the first cell search operation. The UE 315-a may further decode a reference signal (e.g., PBCH DMRS) based on receiving the one or more synchronization signals. In some examples, the transmitted cell measurement-related information may include information associated with the one or more synchronization signals, information associated with the reference signal, or both. In some examples, the obtained cell selection information may be associated with a first subset of SSBs of a set of multiple of SSBs associated with the first cell.

In some examples, the UE 315-a may further obtain cell selection information that includes system information, which may facilitate the performance of the second cell search operation. In some examples, the UE 315-a may obtain the system information during a connection establishment operation with the network entity 105 or based on a network configuration change at the network entity 105. In some examples, the obtained cell selection information may be associated with a first portion of system information associated with the first cell.

In some examples, the UE 315-a may receive one or more SIBs associated with the first cell that include first information associated with one or more second cells (e.g., associated with another network entity (not shown)) different than the first cell, and the transmitted cell measurement-related information may include the first information. In some examples, the first information may include cell remeasurement-related information that includes priority information associated with the one or more second cells, one or more threshold values associated with the one or more second cells, one or more offsets associated with the one or more second cells, frequency information associated with the one or more second cells, one or more measurement configurations associated with the one or more second cells, or any combination thereof. Additionally, or alternatively, the transmitted cell measurement-related information may include second information associated with the one or more second cells, the second information may be indicative of a search window for SSBs, a list of second cells that are detectable by the UE 315-a, a power change of a second cell, a list of second cells that are not to be considered for cell reselection, or any combination thereof.

At 335, the UE 315-a may establish a connection with the network entity 105 in accordance with the obtained cell selection information and transmitting (e.g., sharing) the cell measurement-related information may be based on establishing the connection.

At 340, in some examples, the UE 315-a may receive, from a UE 315-b of the one or more UEs 315-b, a request for system information (e.g., or other cell selection information), and transmitting the system information may be based on the request. At 345, in some examples, the UE 315-a may transmit, to the network entity 105, a request for the system information (e.g., or other cell selection information), and obtaining system information may be based on transmitting the request.

At 350, the UE 315-a may transmit the cell selection information (e.g., cell measurement-related information, system information) to the one or more UEs 315-b of the set of UEs based on obtaining the cell measurement-related information. In some examples, the threshold distance (e.g., that determines the set of UEs or group of UEs) may be associated with a set of one or more beams of the network entity 105, and the UE 315-a and the one or more UEs 315-b may be located within the set of one or more beams. Additionally, or alternatively, the threshold distance may be associated with a set of one or more cells of the network entity 105, and the UE 315-a and the one or more UEs 315-b may be located within the set of one or more cells of the network entity 105. In some examples, at least one of the UE 315-a or the one or more UEs 315-b may be in an RRC inactive mode.

In some examples, the UE 315-a may transmit the cell selection information via a broadcast channel, a sidelink channel, a WLAN link, a Bluetooth link, or any combination thereof. In some examples, the UE 315-a may determine to transmit the cell selection information based on a battery level of the UE 315-a, a connection state of the UE 315-a, a capability of the UE 315-a, or any combination thereof. In some examples, the UE 315-a may transmit the cell selection information to the one or more UEs 315-b based on the UE 315-a satisfying a policy defined (e.g., signaled) by the network entity 105.

In some examples, the UE 315-a may transmit, via the cell selection information, capability information associated with the UE 315-a. The capability information may include one or more supported frequency bands, a power capability, an antenna configuration, or any combination thereof. Additionally, or alternatively, the UE 315-a may transmit, via the cell selection information, first information associated with performing the first cell search operation, the first information indicative of one or more searched frequency ranges, one or more searched cell identifiers, or both, and the second cell search operation may be simplified based on the first information. Additionally, or alternatively, the UE 315-a may transmit, via the cell measurement-related information, an indication of one or more frequency ranges, one or more cells, one or more beams, or any combination thereof for which the one or more UEs 315-b are to deprioritize search operations, and the second cell search operation is simplified based on the indication.

At 360, in some examples, the UE 315-b perform a cell search operation that is simplified with respect to the first cell search operation performed by the UE 315-a. In some examples, the UE 315-b may also obtain second information associated with a second subset of SSBs of a set of multiple of SSBs different than the first subset of SSBs (e.g., based on the shared information from the UE 315-a). Additionally, or alternatively, the UE 315-b may obtain a second portion of the system information associated with the first cell different than the first portion (e.g., based on the shared information from the UE 315-a). In some examples, the UE 315-b may obtain other cell selection information from one or more other UEs (not shown) that facilitates the simplified cell search operation.

At 365, the UE 315-b may establish a connection with the network entity 105 in accordance with the cell selection information (e.g., cell measurement-related information, system information) received from the UE 315-a. In some examples, establishing the connection may include applying one or more first offsets to the cell selection information received from the UE 315-a, the one or more first offsets including a time offset, a frequency offset, a range-based offset, an SSB index offset, or any combination thereof. In some examples, establishing the connection may be based on utilizing, as part of a cell selection operation, a same SSB index as an SSB index included in the received cell selection information to establish the connection. In some examples, establishing the connection may be based on evaluating, as part of a cell selection operation, a subset of SSBs of a set of multiple of SSBs associated with the first cell. In some examples, the subset of SSBs may be based on an SSB index included in the received cell selection information. In some examples, establishing the connection with the one or more UEs 315-b may be based on the network entity 105 refraining from transmitting the cell selection information or based on the policy indicated by the network entity 105.

At 370, in some examples, the UE 315-a may receive second cell selection information from one or more UEs 315-b (e.g., the UE 315-b may share), and the second cell selection information may be associated with a second subset of SSBs of the set of multiple of SSBs different than the first subset of SSBs (e.g., different than the SSBs measured by the UE 315-a). Additionally, or alternatively, the UE 315-a may receive, from one of the one or more UEs 315-b, second cell selection information associated with a second portion of the system information associated with the first cell different than the first portion (e.g., different than the system information obtained by the UE 315-a). In some examples, the UE 315-a and the one or more UEs 315-b may not be associated with a U2N relay framework.

At 375, in some examples, the UE 315-b may transmit (e.g., forward, send) the received cell selection information to one or more other UEs (not shown), which may be included in the set (e.g., a group 220), based on receiving the cell selection information (e.g., in a multi-hop example). That is, the UE 315-b may assist other UEs while being assisted by the UE 315-a. In some examples, the UE 315-b and the one or more other UEs may within a second threshold distance of each other (e.g., which may be different than the threshold distance between the UE 315-b and the UE 315-a).

At 380, in some examples, the UE 315-a may select a second cell (e.g., of the one or more second cells indicated in the cell selection information). In some examples, transmitting cell selection information to the UE 315-b may be based on selecting the second cell (e.g., a cell reselection operation, based on a cell switch). At 385, in some examples, the UE 315-b may also select a second cell of the one or more second cells based on receiving the cell selection information.

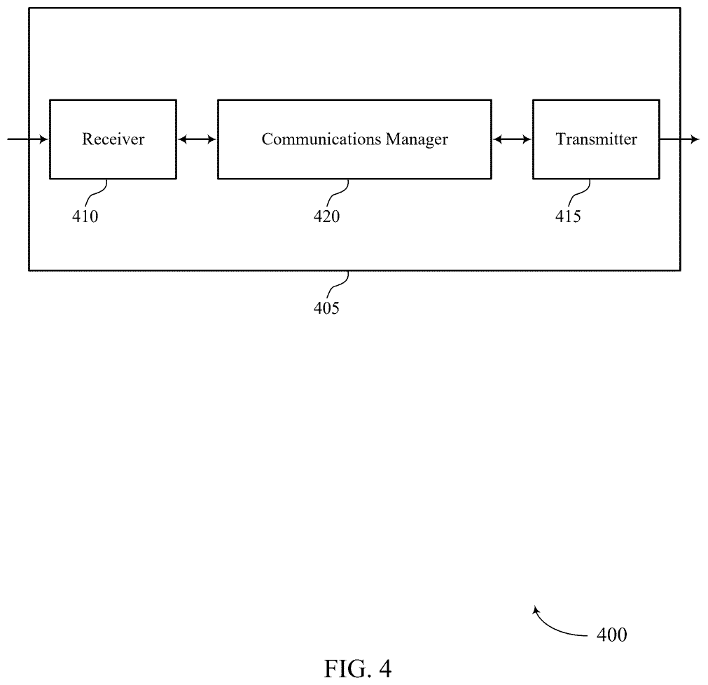

FIG. 4 shows a block diagram 400 of a device 405 that supports techniques for UE assisted cell selection in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for UE assisted cell selection). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for UE assisted cell selection). In some examples, the transmitter 415 may be co-located with a receiver 410 in a transceiver component. The transmitter 415 may utilize a single antenna or a set of multiple antennas.

The communications manager 420, the receiver 410, the transmitter 415, or various combinations or components thereof may be examples of means for performing various aspects of techniques for UE assisted cell selection as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for performing a first cell search operation to initiate selection of a first cell associated with a network entity. The communications manager 420 is capable of, configured to, or operable to support a means for obtaining cell measurement-related information that facilitates performance, by one or more second UEs of a set of UEs, of a second cell search operation to initiate selection of the first cell based on performing the first cell search operation, where the second cell search operation is simplified with respect to the first cell search operation. The communications manager 420 is capable of, configured to, or operable to support a means for transmitting the cell measurement-related information to the one or more second UEs of the set of UEs based on obtaining the cell measurement-related information, where the first UE and the one or more second UEs are included in the set of UEs based on the first UE and the one or more second UEs being within a threshold distance of each other.

Additionally, or alternatively, the communications manager 420 may support wireless communications in accordance with examples as disclosed herein. For example, the communications manager 420 is capable of, configured to, or operable to support a means for receiving, from a first UE of a set of UEs, cell measurement-related information that facilitates selecting a first cell associated with a network entity, where the first UE and the second UE are included in the set of UEs based on the first UE and the second UE being within a threshold distance of each other. The communications manager 420 is capable of, configured to, or operable to support a means for establishing a connection with the network entity in accordance with the cell measurement-related information received from the first UE.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, and more efficient utilization of communication resources, among other benefits.

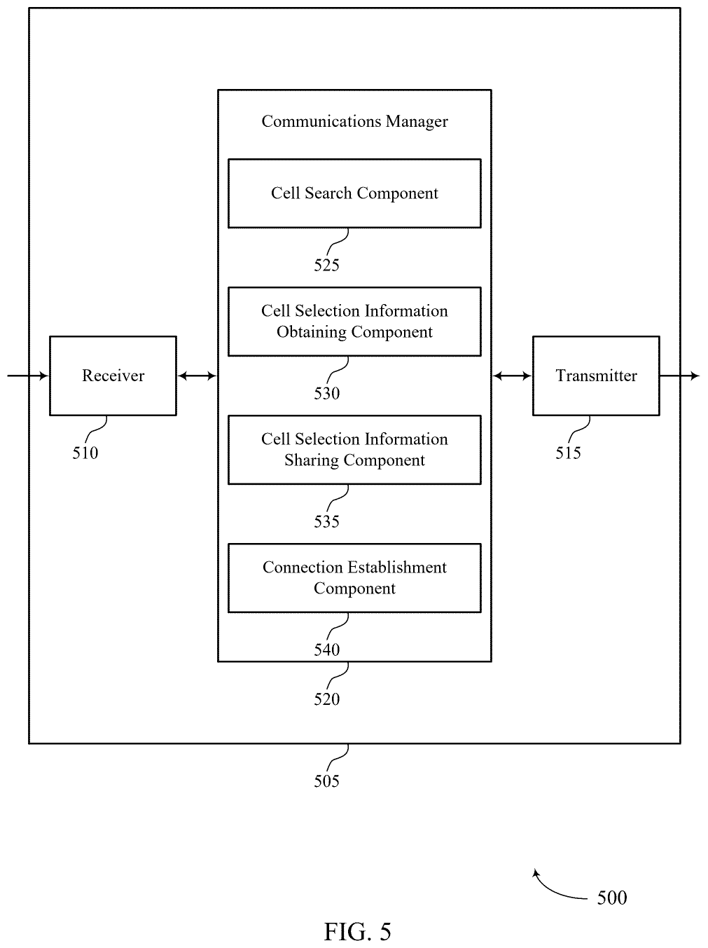

FIG. 5 shows a block diagram 500 of a device 505 that supports techniques for UE assisted cell selection in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for UE assisted cell selection). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for UE assisted cell selection). In some examples, the transmitter 515 may be co-located with a receiver 510 in a transceiver component. The transmitter 515 may utilize a single antenna or a set of multiple antennas.

The device 505, or various components thereof, may be an example of means for performing various aspects of techniques for UE assisted cell selection as described herein. For example, the communications manager 520 may include a cell search component 525, a cell selection information obtaining component 530, a cell selection information sharing component 535, a connection establishment component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The cell search component 525 is capable of, configured to, or operable to support a means for performing a first cell search operation to initiate selection of a first cell associated with a network entity. The cell selection information obtaining component 530 is capable of, configured to, or operable to support a means for obtaining cell measurement-related information that facilitates performance, by one or more second UEs of a set of UEs, of a second cell search operation to initiate selection of the first cell based on performing the first cell search operation, where the second cell search operation is simplified with respect to the first cell search operation. The cell selection information sharing component 535 is capable of, configured to, or operable to support a means for transmitting the cell measurement-related information to the one or more second UEs of the set of UEs based on obtaining the cell measurement-related information, where the first UE and the one or more second UEs are included in the set of UEs based on the first UE and the one or more second UEs being within a threshold distance of each other.

Additionally, or alternatively, the communications manager 520 may support wireless communications in accordance with examples as disclosed herein. The cell selection information obtaining component 530 is capable of, configured to, or operable to support a means for receiving, from a first UE of a set of UEs, cell measurement-related information that facilitates selecting a first cell associated with a network entity, where the first UE and the second UE are included in the set of UEs based on the first UE and the second UE being within a threshold distance of each other. The connection establishment component 540 is capable of, configured to, or operable to support a means for establishing a connection with the network entity in accordance with the cell measurement-related information received from the first UE.

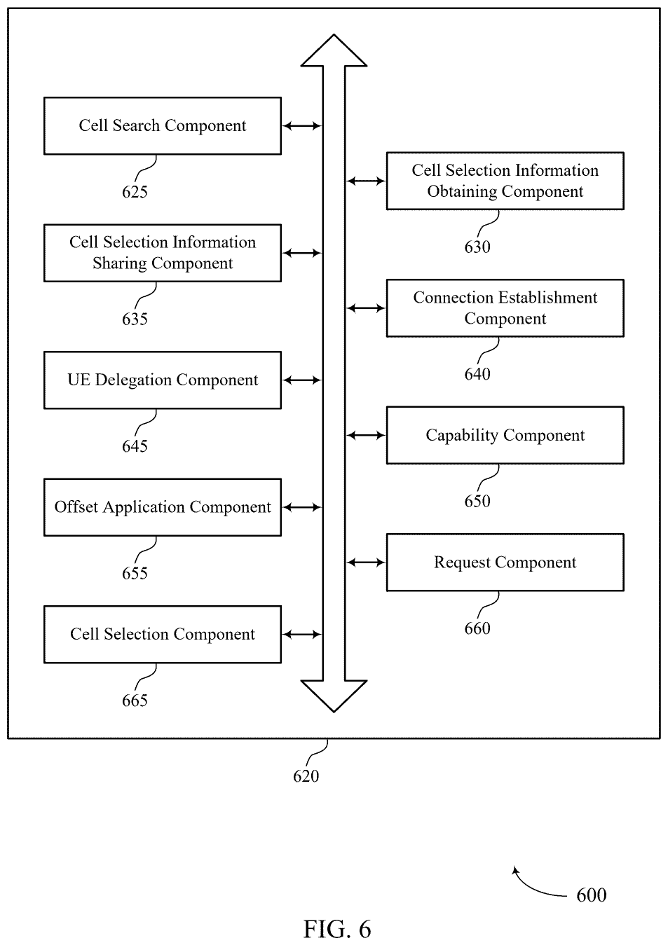

FIG. 6 shows a block diagram 600 of a communications manager 620 that supports techniques for UE assisted cell selection in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for UE assisted cell selection as described herein. For example, the communications manager 620 may include a cell search component 625, a cell selection information obtaining component 630, a cell selection information sharing component 635, a connection establishment component 640, a UE delegation component 645, a capability component 650, an offset application component 655, a request component 660, a cell selection component 665, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The cell search component 625 is capable of, configured to, or operable to support a means for performing a first cell search operation to initiate selection of a first cell associated with a network entity. The cell selection information obtaining component 630 is capable of, configured to, or operable to support a means for obtaining cell measurement-related information that facilitates performance, by one or more second UEs of a set of UEs, of a second cell search operation to initiate selection of the first cell based on performing the first cell search operation, where the second cell search operation is simplified with respect to the first cell search operation. The cell selection information sharing component 635 is capable of, configured to, or operable to support a means for transmitting the cell measurement-related information to the one or more second UEs of the set of UEs based on obtaining the cell measurement-related information, where the first UE and the one or more second UEs are included in the set of UEs based on the first UE and the one or more second UEs being within a threshold distance of each other.

In some examples, the cell measurement-related information includes cell measurement configuration information, cell measurement result information, or both.

In some examples, the cell selection information obtaining component 630 is capable of, configured to, or operable to support a means for obtaining system information that facilitates the performance of the second cell search operation. In some examples, the cell selection information sharing component 635 is capable of, configured to, or operable to support a means for transmitting the system information to the one or more second UEs of the set of UEs based on obtaining the system information.

In some examples, to support obtaining the system information, the cell selection information obtaining component 630 is capable of, configured to, or operable to support a means for obtaining the system information during a connection establishment operation with the network entity or based on a network configuration change at the network entity.

In some examples, the request component 660 is capable of, configured to, or operable to support a means for receiving, from a second UE of the one or more second UEs, a request for the system information, where transmitting the system information is based on receiving the request.

In some examples, the request component 660 is capable of, configured to, or operable to support a means for transmitting, to the network entity, a request for the system information, where obtaining the system information is based on transmitting the request.

In some examples, to support obtaining the cell measurement-related information, the cell selection information obtaining component 630 is capable of, configured to, or operable to support a means for receiving one or more synchronization signals from the network entity based on performing the first cell search operation. In some examples, to support obtaining the cell measurement-related information, the cell selection information obtaining component 630 is capable of, configured to, or operable to support a means for decoding a reference signal based on receiving the one or more synchronization signals, where the transmitted cell measurement-related information includes first information associated with the one or more synchronization signals, second information associated with the reference signal, or both.

In some examples, the connection establishment component 640 is capable of, configured to, or operable to support a means for establishing a connection with the network entity in accordance with the first information, the second information, or both, where transmitting the cell measurement-related information is based on establishing the connection.

In some examples, to support obtaining the cell measurement-related information, the cell selection information obtaining component 630 is capable of, configured to, or operable to support a means for receiving one or more system information blocks (SIBs) associated with the first cell that include first information associated with one or more second cells different than the first cell, the transmitted cell measurement-related information including the first information.

In some examples, the first information includes cell remeasurement-related information that includes priority information associated with the one or more second cells, one or more threshold values associated with the one or more second cells, one or more offsets associated with the one or more second cells, frequency information, one or more measurement configurations associated with the one or more second cells, or any combination thereof.

In some examples, the cell selection component 665 is capable of, configured to, or operable to support a means for selecting a second cell of the one or more second cells, where transmitting the cell measurement-related information is based on selecting the second cell.

In some examples, the transmitted cell measurement-related information further includes second information associated with the one or more second cells, the second information indicative of a search window for synchronization signal blocks (SSBs), a list of second cells that are detectable by the first UE, a power change of a second cell, a list of second cells that are not to be considered for cell reselection, or any combination thereof.

In some examples, to support transmitting the cell measurement-related information, the cell selection information sharing component 635 is capable of, configured to, or operable to support a means for transmitting the cell measurement-related information via a broadcast channel, a sidelink channel, a wireless local-area network (WLAN), a Bluetooth link, or any combination thereof.

In some examples, the threshold distance is associated with a set of one or more beams of the network entity, the first UE and the one or more second UEs being located within the set of one or more beams.

In some examples, the threshold distance is associated with a set of one or more cells of the network entity, the first UE and the one or more second UEs being located within the set of one or more cells of the network entity.

In some examples, at least one of the first UE or the one or more second UEs are in an RRC inactive mode.

In some examples, the UE delegation component 645 is capable of, configured to, or operable to support a means for determining to transmit the cell measurement-related information based on a battery level of the first UE, a connection state of the first UE, a capability of the first UE, or any combination thereof.

In some examples, transmitting the cell measurement-related information to the one or more second UEs is based on the first UE satisfying a policy defined by the network entity.

In some examples, the capability component 650 is capable of, configured to, or operable to support a means for transmitting, via the cell measurement-related information, capability information associated with the first UE, the capability information including one or more supported frequency bands, a power capability, an antenna configuration, or any combination thereof.

In some examples, the cell selection information sharing component 635 is capable of, configured to, or operable to support a means for transmitting, via the cell measurement-related information, first information associated with performing the first cell search operation, the first information indicative of one or more searched frequency ranges, one or more searched cell identifiers, or both, where the second cell search operation is simplified based on transmitting the first information.

In some examples, the cell selection information sharing component 635 is capable of, configured to, or operable to support a means for transmitting, via the cell measurement-related information, an indication of one or more frequency ranges, one or more cells, one or more beams, or any combination thereof for which the one or more second UEs are to deprioritize search operations, where the second cell search operation is simplified based on transmitting the indication.

In some examples, the cell measurement-related information is associated with a first subset of synchronization signal blocks (SSBs) of a set of multiple SSBs associated with the first cell, and the cell selection information obtaining component 630 is capable of, configured to, or operable to support a means for receiving, from one of the one or more second UEs, second information associated with a second subset of SSBs of the set of multiple SSBs different than the first subset of SSBs.

In some examples, the cell measurement-related information is associated with a first portion of system information associated with the first cell, and the cell selection information obtaining component 630 is capable of, configured to, or operable to support a means for receiving, from one of the one or more second UEs, second information associated with a second portion of the system information associated with the first cell different than the first portion. In some examples, the first UE and the one or more second UEs are not associated with a UE to network (U2N) relay framework.

Additionally, or alternatively, the communications manager 620 may support wireless communications in accordance with examples as disclosed herein. In some examples, the cell selection information obtaining component 630 is capable of, configured to, or operable to support a means for receiving, from a first UE of a set of UEs, cell measurement-related information that facilitates selecting a first cell associated with a network entity, where the first UE and the second UE are included in the set of UEs based on the first UE and the second UE being within a threshold distance of each other. The connection establishment component 640 is capable of, configured to, or operable to support a means for establishing a connection with the network entity in accordance with the cell measurement-related information received from the first UE.

In some examples, the cell selection information obtaining component 630 is capable of, configured to, or operable to support a means for receiving system information that facilitates selecting the first cell, where establishing the connection with the network entity is further in accordance with the system information.

In some examples, the request component 660 is capable of, configured to, or operable to support a means for transmitting, to the first UE, a request for the system information, where receiving the system information is based on transmitting the request.

In some examples, the received cell measurement-related information includes cell measurement configuration information associated with the first cell, cell measurement result information associated with the first cell, first information associated with one or more synchronization signals of the first cell, second information associated with a reference signal of the first cell, or any combination thereof.

In some examples, to support establishing the connection, the offset application component 655 is capable of, configured to, or operable to support a means for applying one or more first offsets to the cell measurement-related information received from the first UE, the one or more first offsets including a time offset, a frequency offset, a range-based offset, a synchronization signal block (SSB) index offset, or any combination thereof.

In some examples, to support establishing the connection, the connection establishment component 640 is capable of, configured to, or operable to support a means for utilizing, as part of a cell selection operation, a same synchronization signal block (SSB) index as an SSB index included in the received cell measurement-related information to establish the connection.

In some examples, to support establishing the connection, the connection establishment component 640 is capable of, configured to, or operable to support a means for evaluating, as part of a cell selection operation, a subset of synchronization signal blocks (SSBs) of a set of multiple SSBs associated with the first cell, the subset of SSBs based on an SSB index included in the received cell measurement-related information.

In some examples, the cell measurement-related information further facilitates selecting one or more second cells different than the first cell, the cell measurement-related information including priority information associated with the first cell and the one or more second cells, frequency information associated with the first cell and the one or more second cells, or any combination thereof.

In some examples, the cell selection component 665 is capable of, configured to, or operable to support a means for selecting a second cell of the one or more second cells based on receiving the cell measurement-related information.

In some examples, the cell measurement-related information is further indicative of a search window for synchronization signal blocks (SSBs), a list of second cells that are detectable by the first UE, a power change of a second cell, a list of second cells that are not to be considered for cell reselection, or any combination thereof.

In some examples, to support receiving the cell measurement-related information, the cell selection information obtaining component 630 is capable of, configured to, or operable to support a means for receiving the cell measurement-related information via a broadcast channel, a sidelink channel, a wireless local-area network (WLAN), a Bluetooth link, or any combination thereof.

In some examples, the threshold distance is associated with a beam of the network entity, the first UE and the second UE being located within the beam.

In some examples, the threshold distance is associated with a cell of the network entity, the first UE and the second UE being located within the cell.

In some examples, the first UE or the second UE are in an RRC inactive mode.

In some examples, the cell selection information sharing component 635 is capable of, configured to, or operable to support a means for transmitting the cell measurement-related information to one or more third UEs based on receiving the cell measurement-related information, where the second UE and the one or more third UEs are within a second threshold distance of each other.

In some examples, establishing the connection in accordance with the received cell measurement-related information is based on the second UE satisfying a policy defined by the network entity.

In some examples, the capability component 650 is capable of, configured to, or operable to support a means for receiving, via the cell measurement-related information, capability information associated with the first UE, the capability information including one or more supported frequency bands, a power capability, an antenna configuration, or any combination thereof.

In some examples, the cell selection information obtaining component 630 is capable of, configured to, or operable to support a means for receiving, via the cell measurement-related information, first information associated with one or more searching operations performed by the first UE, the first information including one or more searched frequency ranges, one or more searched cell identifiers, or both.

In some examples, the cell selection information obtaining component 630 is capable of, configured to, or operable to support a means for receiving, via the cell measurement-related information, an indication of one or more frequency ranges, one or more cells, one or more beams, or any combination thereof for which the second UE is to deprioritize search operations.

In some examples, the cell measurement-related information is associated with a first subset of synchronization signal blocks (SSBs) of a set of multiple SSBs associated with the first cell, and the cell selection information obtaining component 630 is capable of, configured to, or operable to support a means for obtaining second information associated with a second subset of SSBs of the set of multiple SSBs different than the first subset of SSBs. In some examples, the cell measurement-related information is associated with a first subset of synchronization signal blocks (SSBs) of a set of multiple SSBs associated with the first cell, and the cell selection information sharing component 635 is capable of, configured to, or operable to support a means for transmitting the second information to the first UE, one or more third UEs, or both.

In some examples, the cell measurement-related information is associated with a first portion of system information associated with the first cell, and the cell selection information obtaining component 630 is capable of, configured to, or operable to support a means for obtaining a second portion of the system information associated with the first cell different than the first portion. In some examples, the cell measurement-related information is associated with a first portion of system information associated with the first cell, and the cell selection information sharing component 635 is capable of, configured to, or operable to support a means for transmitting second information including the second portion of the system information to the first UE, one or more third UEs, or both.

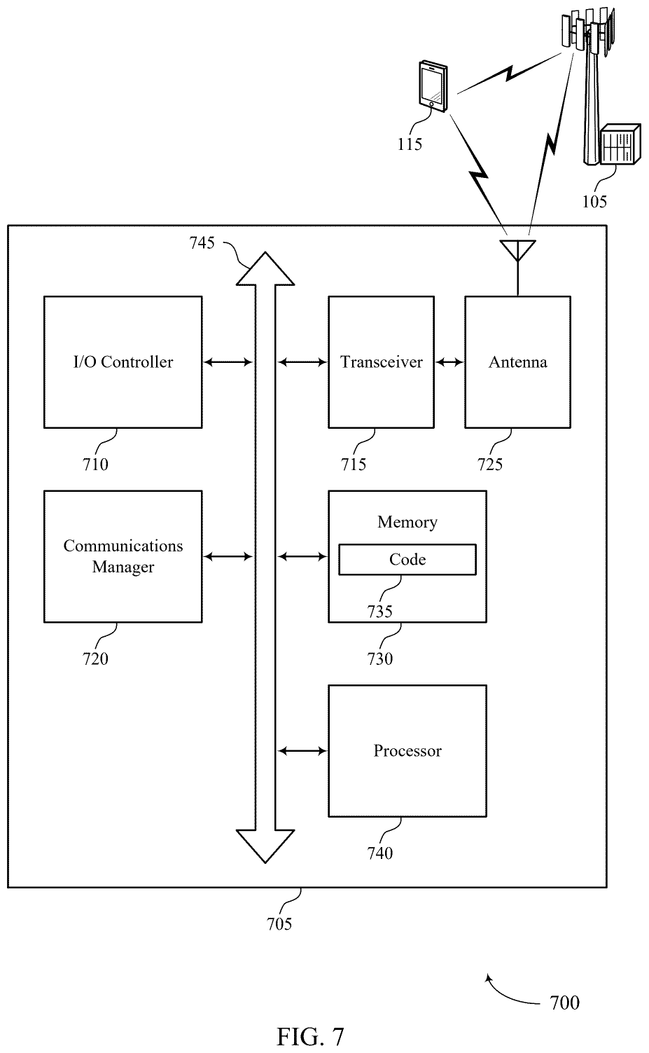

FIG. 7 shows a diagram of a system 700 including a device 705 that supports techniques for UE assisted cell selection in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for UE assisted cell selection). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for performing a first cell search operation to initiate selection of a first cell associated with a network entity. The communications manager 720 is capable of, configured to, or operable to support a means for obtaining cell measurement-related information that facilitates performance, by one or more second UEs of a set of UEs, of a second cell search operation to initiate selection of the first cell based on performing the first cell search operation, where the second cell search operation is simplified with respect to the first cell search operation. The communications manager 720 is capable of, configured to, or operable to support a means for transmitting the cell measurement-related information to the one or more second UEs of the set of UEs based on obtaining the cell measurement-related information, where the first UE and the one or more second UEs are included in the set of UEs based on the first UE and the one or more second UEs being within a threshold distance of each other.

Additionally, or alternatively, the communications manager 720 may support wireless communications in accordance with examples as disclosed herein. For example, the communications manager 720 is capable of, configured to, or operable to support a means for receiving, from a first UE of a set of UEs, cell measurement-related information that facilitates selecting a first cell associated with a network entity, where the first UE and the second UE are included in the set of UEs based on the first UE and the second UE being within a threshold distance of each other. The communications manager 720 is capable of, configured to, or operable to support a means for establishing a connection with the network entity in accordance with the cell measurement-related information received from the first UE.

By including or configuring the communications manager 720 in accordance with examples as described herein, the device 705 may support techniques for improved user experience related to reduced processing, reduced power consumption, more efficient utilization of communication resources, improved coordination between devices, longer battery life, and improved utilization of processing capability, among other benefits.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for UE assisted cell selection as described herein, or the at least one processor 740 and the at least one memory 730 may be otherwise configured to, individually or collectively, perform or support such operations.

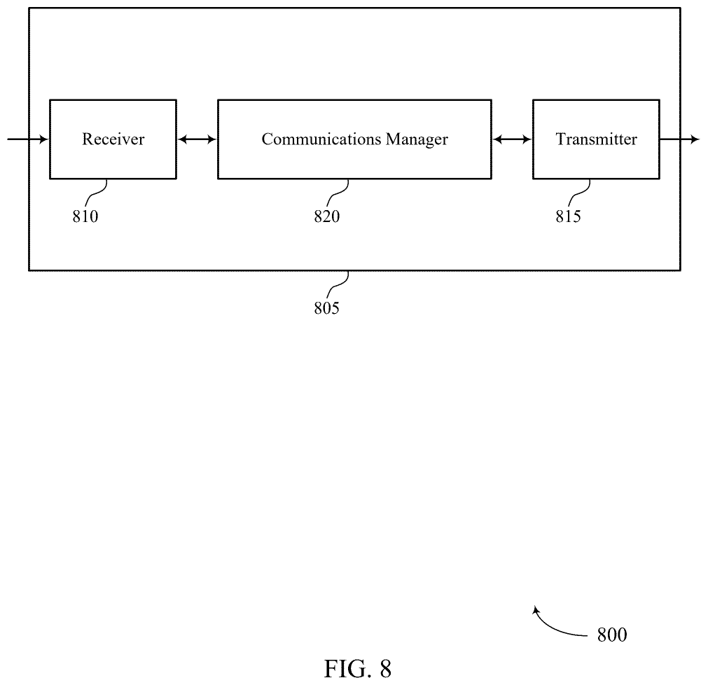

FIG. 8 shows a block diagram 800 of a device 805 that supports techniques for UE assisted cell selection in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for UE assisted cell selection as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting, to a first UE, cell measurement-related information that facilitates selection of a cell associated with the network entity, where the network entity is configured to communicate with a set of UEs including the first UE and one or more second UEs, and where the first UE and the one or more second UEs are included in the set of UEs based on the first UE and the one or more second UEs being within a threshold distance of each other. The communications manager 820 is capable of, configured to, or operable to support a means for establishing a connection with the one or more second UEs based on outputting the cell measurement-related information to the first UE.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources, among other benefits.

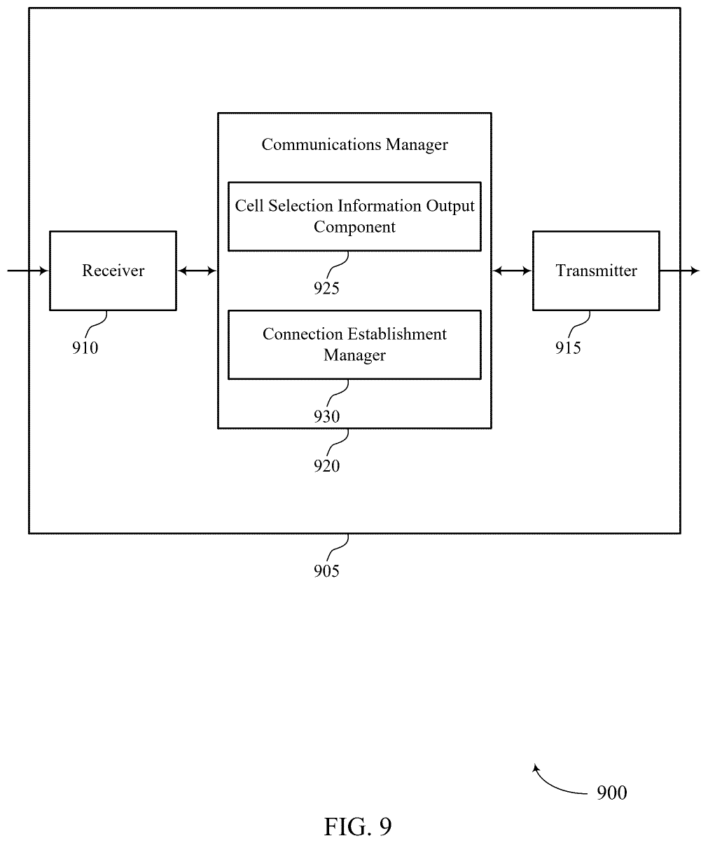

FIG. 9 shows a block diagram 900 of a device 905 that supports techniques for UE assisted cell selection in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for UE assisted cell selection as described herein. For example, the communications manager 920 may include a cell selection information output component 925 a connection establishment manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The cell selection information output component 925 is capable of, configured to, or operable to support a means for outputting, to a first UE, cell measurement-related information that facilitates selection of a cell associated with the network entity, where the network entity is configured to communicate with a set of UEs including the first UE and one or more second UEs, and where the first UE and the one or more second UEs are included in the set of UEs based on the first UE and the one or more second UEs being within a threshold distance of each other. The connection establishment manager 930 is capable of, configured to, or operable to support a means for establishing a connection with the one or more second UEs based on outputting the cell measurement-related information to the first UE.

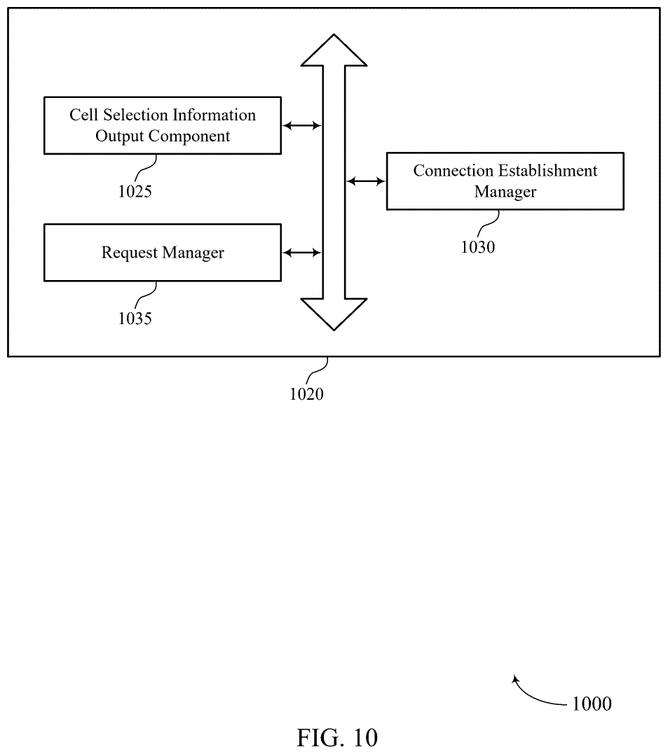

FIG. 10 shows a block diagram 1000 of a communications manager 1020 that supports techniques for UE assisted cell selection in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for UE assisted cell selection as described herein. For example, the communications manager 1020 may include a cell selection information output component 1025, a connection establishment manager 1030, a request manager 1035, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The cell selection information output component 1025 is capable of, configured to, or operable to support a means for outputting, to a first UE, cell measurement-related information that facilitates selection of a cell associated with the network entity, where the network entity is configured to communicate with a set of UEs including the first UE and one or more second UEs, and where the first UE and the one or more second UEs are included in the set of UEs based on the first UE and the one or more second UEs being within a threshold distance of each other. The connection establishment manager 1030 is capable of, configured to, or operable to support a means for establishing a connection with the one or more second UEs based on outputting the cell measurement-related information to the first UE.

In some examples, the connection establishment manager 1030 is capable of, configured to, or operable to support a means for refraining from outputting the cell measurement-related information to the one or more second UEs, where establishing the connection with the one or more second UEs is based on the refraining.

In some examples, the cell measurement-related information includes cell measurement configuration information.

In some examples, the cell measurement configuration information includes a policy defined by the network entity, the policy identifying one or more conditions that are to be satisfied by the first UE. In some examples, establishing the connection is based on the policy.

In some examples, the cell selection information output component 1025 is capable of, configured to, or operable to support a means for outputting, to the first UE, system information that facilitates selection of the cell, where establishing the connection with the one or more second UEs based on outputting the system information.

In some examples, the connection establishment manager 1030 is capable of, configured to, or operable to support a means for refraining from outputting the system information to the one or more second UEs, where establishing the connection with the one or more second UEs is based on the refraining.

In some examples, to support outputting the system information, the cell selection information output component 1025 is capable of, configured to, or operable to support a means for outputting the system information during a connection establishment operation with the first UE. In some examples, to support outputting the system information, the cell selection information output component 1025 is capable of, configured to, or operable to support a means for outputting the system information based on a network configuration change at the network entity.

In some examples, the request manager 1035 is capable of, configured to, or operable to support a means for receiving, from the first UE, a request for the system information, where outputting the system information is based on receiving the request.

In some examples, the connection establishment manager 1030 is capable of, configured to, or operable to support a means for establishing a second connection with the first UE based on outputting the cell measurement-related information to the first UE.

In some examples, to support outputting the cell measurement-related information, the cell selection information output component 1025 is capable of, configured to, or operable to support a means for outputting one or more system information blocks (SIBs) associated with the cell that include first information associated with one or more second cells different than the cell, the cell measurement-related information including the first information.

In some examples, the first information includes priority information associated with the one or more second cells, frequency information associated with the one or more second cells, or both.

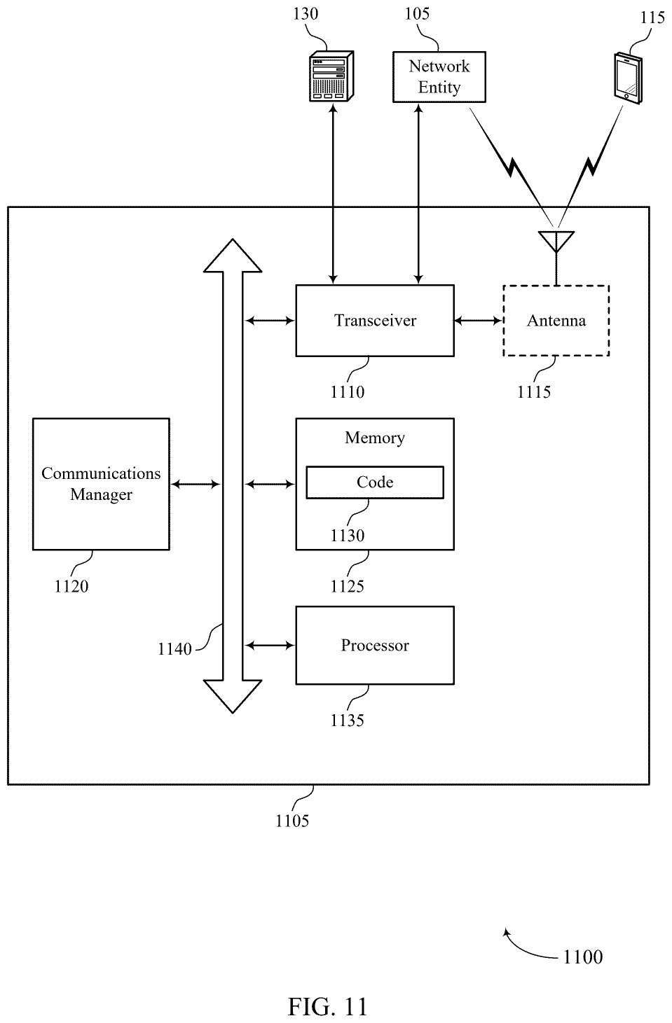

FIG. 11 shows a diagram of a system 1100 including a device 1105 that supports techniques for UE assisted cell selection in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for UE assisted cell selection). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting, to a first UE, cell measurement-related information that facilitates selection of a cell associated with the network entity, where the network entity is configured to communicate with a set of UEs including the first UE and one or more second UEs, and where the first UE and the one or more second UEs are included in the set of UEs based on the first UE and the one or more second UEs being within a threshold distance of each other. The communications manager 1120 is capable of, configured to, or operable to support a means for establishing a connection with the one or more second UEs based on outputting the cell measurement-related information to the first UE.

By including or configuring the communications manager 1120 in accordance with examples as described herein, the device 1105 may support techniques for improved user experience related to reduced processing, reduced power consumption, more efficient utilization of communication resources, improved coordination between devices, longer battery life, and improved utilization of processing capability, among other benefits.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for UE assisted cell selection as described herein, or the at least one processor 1135 and the at least one memory 1125 may be otherwise configured to, individually or collectively, perform or support such operations.

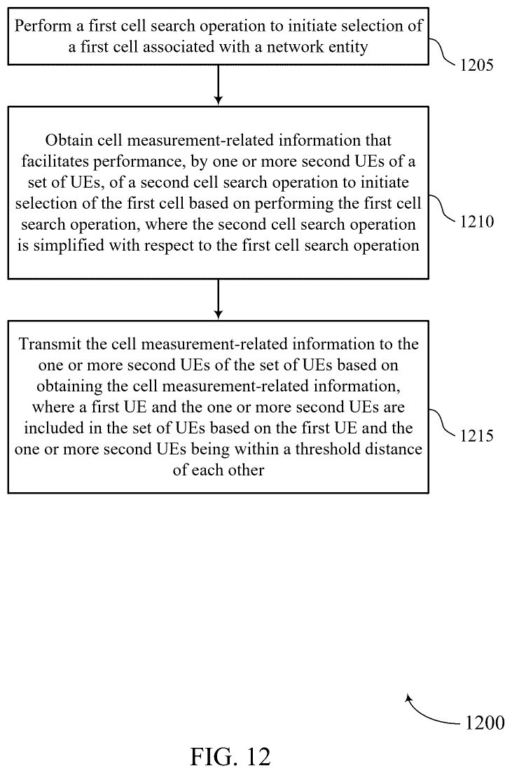

FIG. 12 shows a flowchart illustrating a method 1200 that supports techniques for UE assisted cell selection in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include performing a first cell search operation to initiate selection of a first cell associated with a network entity. The operations of 1205 may be performed in accordance with examples as disclosed herein. In some examples, aspects of the operations of 1205 may be performed by a cell search component 625 as described with reference to FIG. 6.

At 1210, the method may include obtaining cell measurement-related information that facilitates performance, by one or more second UEs of a set of UEs, of a second cell search operation to initiate selection of the first cell based on performing the first cell search operation, where the second cell search operation is simplified with respect to the first cell search operation. The operations of 1210 may be performed in accordance with examples as disclosed herein. In some examples, aspects of the operations of 1210 may be performed by a cell selection information obtaining component 630 as described with reference to FIG. 6.

At 1215, the method may include transmitting the cell measurement-related information to the one or more second UEs of the set of UEs based on obtaining the cell measurement-related information, where a first UE and the one or more second UEs are included in the set of UEs based on the first UE and the one or more second UEs being within a threshold distance of each other. The operations of 1215 may be performed in accordance with examples as disclosed herein. In some examples, aspects of the operations of 1215 may be performed by a cell selection information sharing component 635 as described with reference to FIG. 6.

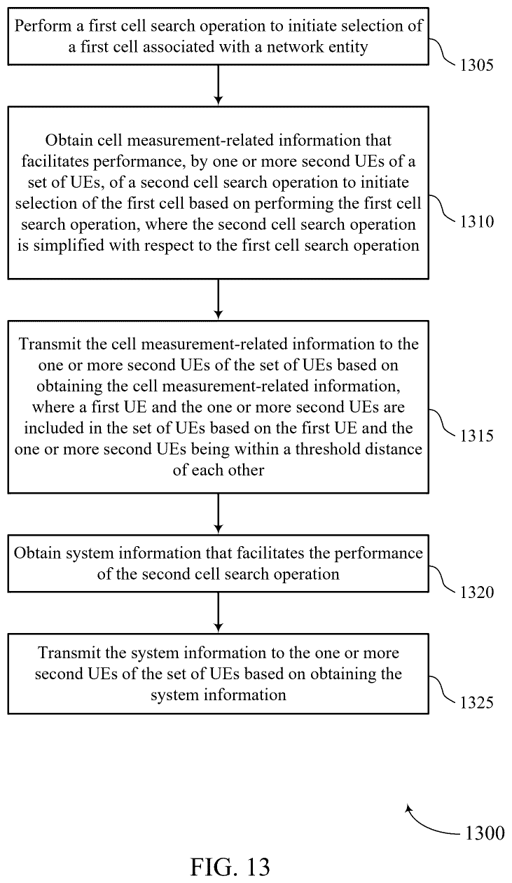

FIG. 13 shows a flowchart illustrating a method 1300 that supports techniques for UE assisted cell selection in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include performing a first cell search operation to initiate selection of a first cell associated with a network entity. The operations of 1305 may be performed in accordance with examples as disclosed herein. In some examples, aspects of the operations of 1305 may be performed by a cell search component 625 as described with reference to FIG. 6.

At 1310, the method may include obtaining cell measurement-related information that facilitates performance, by one or more second UEs of a set of UEs, of a second cell search operation to initiate selection of the first cell based on performing the first cell search operation, where the second cell search operation is simplified with respect to the first cell search operation. The operations of 1310 may be performed in accordance with examples as disclosed herein. In some examples, aspects of the operations of 1310 may be performed by a cell selection information obtaining component 630 as described with reference to FIG. 6.

At 1315, the method may include transmitting the cell measurement-related information to the one or more second UEs of the set of UEs based on obtaining the cell measurement-related information, where a first UE and the one or more second UEs are included in the set of UEs based on the first UE and the one or more second UEs being within a threshold distance of each other. The operations of 1315 may be performed in accordance with examples as disclosed herein. In some examples, aspects of the operations of 1315 may be performed by a cell selection information sharing component 635 as described with reference to FIG. 6.

At 1320, the method may include obtaining system information that facilitates the performance of the second cell search operation. The operations of 1320 may be performed in accordance with examples as disclosed herein. In some examples, aspects of the operations of 1320 may be performed by a cell selection information obtaining component 630 as described with reference to FIG. 6.

At 1325, the method may include transmitting the system information to the one or more second UEs of the set of UEs based on obtaining the system information. The operations of 1325 may be performed in accordance with examples as disclosed herein. In some examples, aspects of the operations of 1325 may be performed by a cell selection information sharing component 635 as described with reference to FIG. 6.

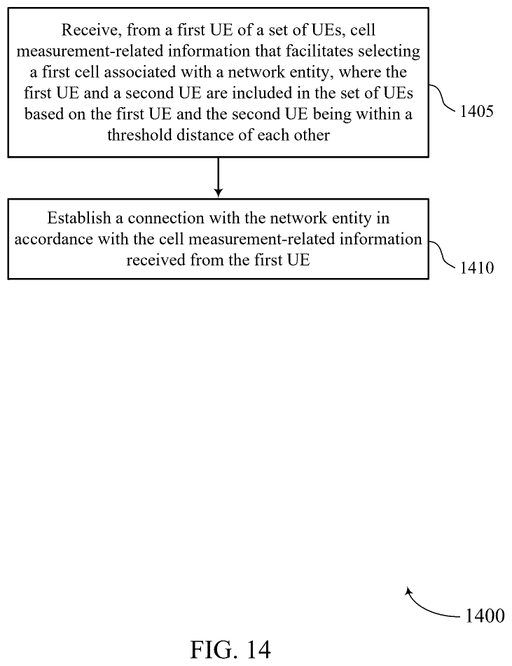

FIG. 14 shows a flowchart illustrating a method 1400 that supports techniques for UE assisted cell selection in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving, from a first UE of a set of UEs, cell measurement-related information that facilitates selecting a first cell associated with a network entity, where the first UE and a second UE are included in the set of UEs based on the first UE and the second UE being within a threshold distance of each other. The operations of 1405 may be performed in accordance with examples as disclosed herein. In some examples, aspects of the operations of 1405 may be performed by a cell selection information obtaining component 630 as described with reference to FIG. 6.

At 1410, the method may include establishing a connection with the network entity in accordance with the cell measurement-related information received from the first UE. The operations of 1410 may be performed in accordance with examples as disclosed herein. In some examples, aspects of the operations of 1410 may be performed by a connection establishment component 640 as described with reference to FIG. 6.

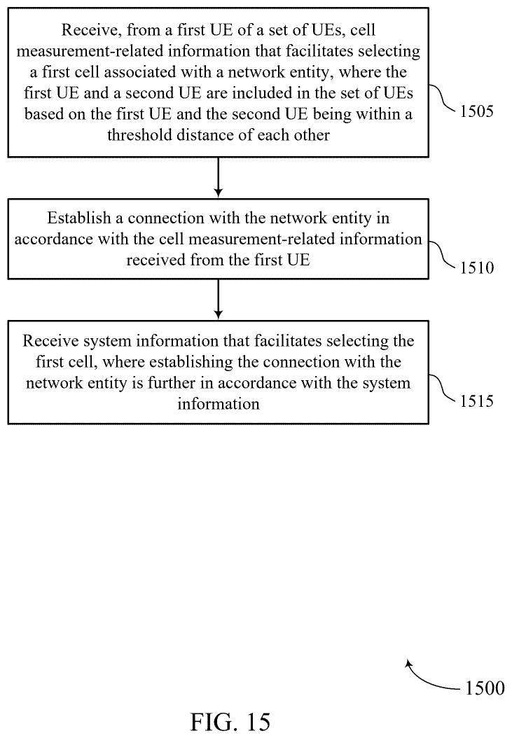

FIG. 15 shows a flowchart illustrating a method 1500 that supports techniques for UE assisted cell selection in accordance with one or more aspects of the present disclosure. The operations of the method 1500 may be implemented by a UE or its components as described herein. For example, the operations of the method 1500 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1505, the method may include receiving, from a first UE of a set of UEs, cell measurement-related information that facilitates selecting a first cell associated with a network entity, where the first UE and a second UE are included in the set of UEs based on the first UE and the second UE being within a threshold distance of each other. The operations of 1505 may be performed in accordance with examples as disclosed herein. In some examples, aspects of the operations of 1505 may be performed by a cell selection information obtaining component 630 as described with reference to FIG. 6.

At 1510, the method may include establishing a connection with the network entity in accordance with the cell measurement-related information received from the first UE. The operations of 1510 may be performed in accordance with examples as disclosed herein. In some examples, aspects of the operations of 1510 may be performed by a connection establishment component 640 as described with reference to FIG. 6.

At 1515, the method may include receiving system information that facilitates selecting the first cell, where establishing the connection with the network entity is further in accordance with the system information. The operations of 1515 may be performed in accordance with examples as disclosed herein. In some examples, aspects of the operations of 1515 may be performed by a cell selection information obtaining component 630 as described with reference to FIG. 6.

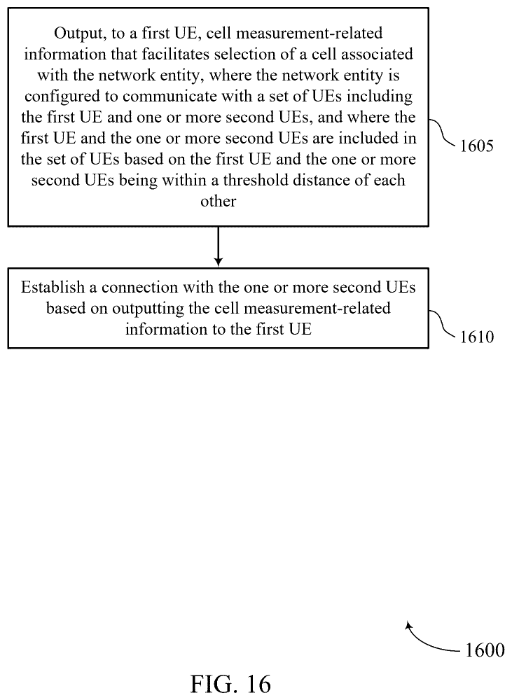

FIG. 16 shows a flowchart illustrating a method 1600 that supports techniques for UE assisted cell selection in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include outputting, to a first UE, cell measurement-related information that facilitates selection of a cell associated with the network entity, where the network entity is configured to communicate with a set of UEs including the first UE and one or more second UEs, and where the first UE and the one or more second UEs are included in the set of UEs based on the first UE and the one or more second UEs being within a threshold distance of each other. The operations of 1605 may be performed in accordance with examples as disclosed herein. In some examples, aspects of the operations of 1605 may be performed by a cell selection information output component 1025 as described with reference to FIG. 10.

At 1610, the method may include establishing a connection with the one or more second UEs based on outputting the cell measurement-related information to the first UE. The operations of 1610 may be performed in accordance with examples as disclosed herein. In some examples, aspects of the operations of 1610 may be performed by a connection establishment manager 1030 as described with reference to FIG. 10.

The following provides an overview of aspects of the present disclosure:

Aspect 1: A method for wireless communications at a first UE, comprising: performing a first cell search operation to initiate selection of a first cell associated with a network entity; obtaining cell measurement-related information that facilitates performance, by one or more second UEs of a set of UEs, of a second cell search operation to initiate selection of the first cell based at least in part on performing the first cell search operation, wherein the second cell search operation is simplified with respect to the first cell search operation; and transmitting the cell measurement-related information to the one or more second UEs of the set of UEs based at least in part on obtaining the cell measurement-related information, wherein the first UE and the one or more second UEs are included in the set of UEs based at least in part on the first UE and the one or more second UEs being within a threshold distance of each other.

Aspect 2: The method of aspect 1, wherein the cell measurement-related information includes cell measurement configuration information, cell measurement result information, or both.

Aspect 3: The method of any of aspects 1 through 2, further comprising: obtaining system information that facilitates the performance of the second cell search operation; and transmitting the system information to the one or more second UEs of the set of UEs based at least in part on obtaining the system information.

Aspect 4: The method of aspect 3, wherein obtaining the system information comprises: obtaining the system information during a connection establishment operation with the network entity or based at least in part on a network configuration change at the network entity.

Aspect 5: The method of any of aspects 3 through 4, further comprising: receiving, from a second UE of the one or more second UEs, a request for the system information, wherein transmitting the system information is based at least in part on receiving the request.

Aspect 6: The method of any of aspects 3 through 5, further comprising: transmitting, to the network entity, a request for the system information, wherein obtaining the system information is based at least in part on transmitting the request.

Aspect 7: The method of any of aspects 1 through 6, wherein obtaining the cell measurement-related information comprises: receiving one or more synchronization signals from the network entity based at least in part on performing the first cell search operation; and decoding a reference signal based at least in part on receiving the one or more synchronization signals, wherein the transmitted cell measurement-related information includes first information associated with the one or more synchronization signals, second information associated with the reference signal, or both.

Aspect 8: The method of aspect 7, further comprising: establishing a connection with the network entity in accordance with the first information, the second information, or both, wherein transmitting the cell measurement-related information is based at least in part on establishing the connection.

Aspect 9: The method of any of aspects 1 through 8, wherein obtaining the cell measurement-related information comprises: receiving one or more SIBs associated with the first cell that include first information associated with one or more second cells different than the first cell, the transmitted cell measurement-related information including the first information.

Aspect 10: The method of aspect 9, wherein the first information includes cell remeasurement-related information that includes priority information associated with the one or more second cells, one or more threshold values associated with the one or more second cells, one or more offsets associated with the one or more second cells, frequency information, one or more measurement configurations associated with the one or more second cells, or any combination thereof.

Aspect 11: The method of any of aspects 9 through 10, further comprising: selecting a second cell of the one or more second cells, wherein transmitting the cell measurement-related information is based at least in part on selecting the second cell.

Aspect 12: The method of any of aspects 9 through 11, wherein the transmitted cell measurement-related information further includes second information associated with the one or more second cells, the second information indicative of a search window for SSBs, a list of second cells that are detectable by the first UE, a power change of a second cell, a list of second cells that are not to be considered for cell reselection, or any combination thereof.

Aspect 13: The method of any of aspects 1 through 12, wherein transmitting the cell measurement-related information comprises: transmitting the cell measurement-related information via a broadcast channel, a sidelink channel, a wireless local-area network, a Bluetooth link, or any combination thereof.

Aspect 14: The method of any of aspects 1 through 13, wherein the threshold distance is associated with a set of one or more beams of the network entity, the first UE and the one or more second UEs being located within the set of one or more beams.

Aspect 15: The method of any of aspects 1 through 13, wherein the threshold distance is associated with a set of one or more cells of the network entity, the first UE and the one or more second UEs being located within the set of one or more cells of the network entity.

Aspect 16: The method of any of aspects 1 through 15, wherein at least one of the first UE or the one or more second UEs are in an RRC inactive mode.

Aspect 17: The method of any of aspects 1 through 16, further comprising: determining to transmit the cell measurement-related information based at least in part on a battery level of the first UE, a connection state of the UE, a capability of the UE, or any combination thereof.

Aspect 18: The method of any of aspects 1 through 17, wherein transmitting the cell measurement-related information to the one or more second UEs is based at least in part on the first UE satisfying a policy defined by the network entity.

Aspect 19: The method of any of aspects 1 through 18, further comprising: transmitting, via the cell measurement-related information, capability information associated with the first UE, the capability information comprising one or more supported frequency bands, a power capability, an antenna configuration, or any combination thereof.

Aspect 20: The method of any of aspects 1 through 19, further comprising: transmitting, via the cell measurement-related information, first information associated with performing the first cell search operation, the first information indicative of one or more searched frequency ranges, one or more searched cell identifiers, or both, wherein the second cell search operation is simplified based at least in part on transmitting the first information.

Aspect 21: The method of any of aspects 1 through 20, further comprising: transmitting, via the cell measurement-related information, an indication of one or more frequency ranges, one or more cells, one or more beams, or any combination thereof for which the one or more second UEs are to deprioritize search operations, wherein the second cell search operation is simplified based at least in part on transmitting the indication.

Aspect 22: The method of any of aspects 1 through 21, wherein the cell measurement-related information is associated with a first subset of SSBs of a plurality of SSBs associated with the first cell, the method further comprising: receiving, from one of the one or more second UEs, second information associated with a second subset of SSBs of the plurality of SSBs different than the first subset of SSBs.

Aspect 23: The method of any of aspects 1 through 22, wherein the cell measurement-related information is associated with a first portion of system information associated with the first cell, the method further comprising: receiving, from one of the one or more second UEs, second information associated with a second portion of the system information associated with the first cell different than the first portion.

Aspect 24: The method of any of aspects 1 through 23, wherein the first UE and the one or more second UEs are not associated with a U2N relay framework.

Aspect 25: A method for wireless communications at a second UE, comprising: receiving, from a first UE of a set of UEs, cell measurement-related information that facilitates selecting a first cell associated with a network entity, wherein the first UE and the second UE are included in the set of UEs based at least in part on the first UE and the second UE being within a threshold distance of each other; and establishing a connection with the network entity in accordance with the cell measurement-related information received from the first UE.

Aspect 26: The method of aspect 25, further comprising: receiving system information that facilitates selecting the first cell, wherein establishing the connection with the network entity is further in accordance with the system information.

Aspect 27: The method of aspect 26, further comprising: transmitting, to the first UE, a request for the system information, wherein receiving the system information is based at least in part on transmitting the request.

Aspect 28: The method of any of aspects 25 through 27, wherein the received cell measurement-related information comprises cell measurement configuration information associated with the first cell, cell measurement result information associated with the first cell, first information associated with one or more synchronization signals of the first cell, second information associated with a reference signal of the first cell, or any combination thereof.

Aspect 29: The method of any of aspects 25 through 28, wherein establishing the connection comprises: applying one or more first offsets to the cell measurement-related information received from the first UE, the one or more first offsets including a time offset, a frequency offset, a range-based offset, an SSB index offset, or any combination thereof.

Aspect 30: The method of any of aspects 25 through 29, wherein establishing the connection comprises: utilizing, as part of a cell selection operation, a same SSB index as an SSB index included in the received cell measurement-related information to establish the connection.

Aspect 31: The method of any of aspects 25 through 30, wherein establishing the connection comprises: evaluating, as part of a cell selection operation, a subset of SSBs of a plurality of SSBs associated with the first cell, the subset of SSBs based at least in part on an SSB index included in the received cell measurement-related information.

Aspect 32: The method of any of aspects 25 through 31, wherein the cell measurement-related information further facilitates selecting one or more second cells different than the first cell, the cell measurement-related information including priority information associated with the first cell and the one or more second cells, frequency information associated with the first cell and the one or more second cells, or any combination thereof.

Aspect 33: The method of aspect 32, further comprising: selecting a second cell of the one or more second cells based at least in part on receiving the cell measurement-related information.

Aspect 34: The method of any of aspects 32 through 33, wherein the cell measurement-related information is further indicative of a search window for SSBs, a list of second cells that are detectable by the first UE, a power change of a second cell, a list of second cells that are not to be considered for cell reselection, or any combination thereof.

Aspect 35: The method of any of aspects 25 through 34, wherein receiving the cell measurement-related information comprises: receiving the cell measurement-related information via a broadcast channel, a sidelink channel, a WLAN, a Bluetooth link, or any combination thereof.

Aspect 36: The method of any of aspects 25 through 35, wherein the threshold distance is associated with a beam of the network entity, the first UE and the second UE being located within the beam.

Aspect 37: The method of any of aspects 25 through 35, wherein the threshold distance is associated with a cell of the network entity, the first UE and the second UE being located within the cell.

Aspect 38: The method of any of aspects 25 through 37, wherein the first UE or the second UE are in an RRC inactive mode.

Aspect 39: The method of any of aspects 25 through 38, further comprising: transmitting the cell measurement-related information to one or more third UEs based at least in part on receiving the cell measurement-related information, wherein the second UE and the one or more third UEs are within a second threshold distance of each other.

Aspect 40: The method of any of aspects 25 through 39, wherein establishing the connection in accordance with the received cell measurement-related information is based at least in part on the second UE satisfying a policy defined by the network entity.

Aspect 41: The method of any of aspects 25 through 40, further comprising: receiving, via the cell measurement-related information, capability information associated with the first UE, the capability information comprising one or more supported frequency bands, a power capability, an antenna configuration, or any combination thereof.

Aspect 42: The method of any of aspects 25 through 41, further comprising: receiving, via the cell measurement-related information, first information associated with one or more searching operations performed by the first UE, the first information including one or more searched frequency ranges, one or more searched cell identifiers, or both.

Aspect 43: The method of any of aspects 25 through 42, further comprising: receiving, via the cell measurement-related information, an indication of one or more frequency ranges, one or more cells, one or more beams, or any combination thereof for which the second UE is to deprioritize search operations.

Aspect 44: The method of any of aspects 25 through 43, wherein the cell measurement-related information is associated with a first subset of SSBs of a plurality of SSBs associated with the first cell, the method further comprising: obtaining second information associated with a second subset of SSBs of the plurality of SSBs different than the first subset of SSBs; and transmitting the second information to the first UE, one or more third UEs, or both.

Aspect 45: The method of any of aspects 25 through 44, wherein the cell measurement-related information is associated with a first portion of system information associated with the first cell, the method further comprising: obtaining a second portion of the system information associated with the first cell different than the first portion; and transmitting second information including the second portion of the system information to the first UE, one or more third UEs, or both.

Aspect 46: A method for wireless communications at a network entity, comprising: outputting, to a first UE, cell measurement-related information that facilitates selection of a cell associated with the network entity, wherein the network entity is configured to communicate with a set of UEs including the first UE and one or more second UEs, and wherein the first UE and the one or more second UEs are included in the set of UEs based at least in part on the first UE and the one or more second UEs being within a threshold distance of each other; and establishing a connection with the one or more second UEs based at least in part on outputting the cell measurement-related information to the first UE.

Aspect 47: The method of aspect 46, further comprising: refraining from outputting the cell measurement-related information to the one or more second UEs, wherein establishing the connection with the one or more second UEs is based at least in part on the refraining

Aspect 48: The method of aspect 46, wherein the cell measurement-related information includes cell measurement configuration information.

Aspect 49: The method of aspect 48, wherein the cell measurement configuration information includes a policy defined by the network entity, the policy identifying one or more conditions that are to be satisfied by the first UE, and establishing the connection is based at least in part on the policy.

Aspect 50: The method of any of aspects 46 through 48, further comprising: outputting, to the first UE, system information that facilitates selection of the cell, wherein establishing the connection with the one or more second UEs based at least in part on outputting the system information.

Aspect 51: The method of aspect 50, further comprising: refraining from outputting the system information to the one or more second UEs, wherein establishing the connection with the one or more second UEs is based at least in part on the refraining.

Aspect 52: The method of aspect 50, wherein outputting the system information comprises: outputting the system information during a connection establishment operation with the first UE; or outputting the system information based at least in part on a network configuration change at the network entity.

Aspect 53: The method of any of aspects 50 through 52, further comprising: receiving, from the first UE, a request for the system information, wherein outputting the system information is based at least in part on receiving the request.

Aspect 54: The method of any of aspects 46 through 53, further comprising: establishing a second connection with the first UE based at least in part on outputting the cell measurement-related information to the first UE.

Aspect 55: The method of any of aspects 46 through 54, wherein outputting the cell measurement-related information comprises: outputting one or more SIBs associated with the cell that include first information associated with one or more second cells different than the cell, the cell measurement-related information including the first information.

Aspect 56: The method of aspect 55, wherein the first information includes priority information associated with the one or more second cells, frequency information associated with the one or more second cells, or both.

Aspect 57: A first UE for wireless communications, comprising one or more memories storing processor-executable code, and one or more processors coupled with the one or more memories and individually or collectively operable to execute the code to cause the first UE to perform a method of any of aspects 1 through 23.

Aspect 58: A first UE for wireless communications, comprising at least one means for performing a method of any of aspects 1 through 23.

Aspect 59: A non-transitory computer-readable medium storing code for wireless communications, the code comprising instructions executable by one or more processors to perform a method of any of aspects 1 through 23.

Aspect 60: A second UE for wireless communications, comprising one or more memories storing processor-executable code, and one or more processors coupled with the one or more memories and individually or collectively operable to execute the code to cause the second UE to perform a method of any of aspects 25 through 45.

Aspect 61: A second UE for wireless communications, comprising at least one means for performing a method of any of aspects 25 through 45.

Aspect 62: A non-transitory computer-readable medium storing code for wireless communications, the code comprising instructions executable by one or more processors to perform a method of any of aspects 25 through 45.

Aspect 63: A network entity for wireless communications, comprising one or more memories storing processor-executable code, and one or more processors coupled with the one or more memories and individually or collectively operable to execute the code to cause the network entity to perform a method of any of aspects 46 through 56.

Aspect 64: A network entity for wireless communications, comprising at least one means for performing a method of any of aspects 46 through 56.

Aspect 65: A non-transitory computer-readable medium storing code for wireless communications, the code comprising instructions executable by one or more processors to perform a method of any of aspects 46 through 56.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
perform a first cell search operation to initiate selection of a first cell associated with a network entity;
obtain cell measurement-related information that facilitates performance, by one or more second UEs of a set of UEs, of a second cell search operation to initiate selection of the first cell based at least in part on performing the first cell search operation, wherein the second cell search operation is simplified with respect to the first cell search operation; and
transmit the cell measurement-related information to the one or more second UEs of the set of UEs based at least in part on obtaining the cell measurement-related information, wherein the first UE and the one or more second UEs are included in the set of UEs based at least in part on the first UE and the one or more second UEs being within a threshold distance of each other.

2. The first UE of claim 1, wherein the cell measurement-related information includes cell measurement configuration information, cell measurement result information, or both.

3. The first UE of claim 1, wherein the one or more processors are individually or collectively further operable to execute the code to cause the first UE to:
obtain system information that facilitates the performance of the second cell search operation; and
transmit the system information to the one or more second UEs of the set of UEs based at least in part on obtaining the system information.

4. The first UE of claim 3, wherein, to obtain the system information, the one or more processors are individually or collectively operable to execute the code to cause the first UE to:
obtain the system information during a connection establishment operation with the network entity or based at least in part on a network configuration change at the network entity.

5. The first UE of claim 3, wherein the one or more processors are individually or collectively further operable to execute the code to cause the first UE to:
receive, from a second UE of the one or more second UEs, a request for the system information, wherein transmitting the system information is based at least in part on receiving the request.

6. The first UE of claim 3, wherein the one or more processors are individually or collectively further operable to execute the code to cause the first UE to:
transmit, to the network entity, a request for the system information, wherein obtaining the system information is based at least in part on transmitting the request.

7. The first UE of claim 1, wherein, to obtain the cell measurement-related information, the one or more processors are individually or collectively operable to execute the code to cause the first UE to:
receive one or more synchronization signals from the network entity based at least in part on performing the first cell search operation; and
decode a reference signal based at least in part on receiving the one or more synchronization signals, wherein the transmitted cell measurement-related information includes first information associated with the one or more synchronization signals, second information associated with the reference signal, or both.

8. The first UE of claim 7, wherein the one or more processors are individually or collectively further operable to execute the code to cause the first UE to:
establish a connection with the network entity in accordance with the first information, the second information, or both, wherein transmitting the cell measurement-related information is based at least in part on establishing the connection.

9. The first UE of claim 1, wherein, to obtain the cell measurement-related information, the one or more processors are individually or collectively operable to execute the code to cause the first UE to:
receive one or more system information blocks (SIBs) associated with the first cell that include first information associated with one or more second cells different than the first cell, the transmitted cell measurement-related information including the first information.

10. The first UE of claim 9, wherein the first information includes cell remeasurement-related information that includes priority information associated with the one or more second cells, one or more threshold values associated with the one or more second cells, one or more offsets associated with the one or more second cells, frequency information, one or more measurement configurations associated with the one or more second cells, or any combination thereof.

11. The first UE of claim 9, wherein the one or more processors are individually or collectively further operable to execute the code to cause the first UE to:
select a second cell of the one or more second cells, wherein transmitting the cell measurement-related information is based at least in part on selecting the second cell.

12. The first UE of claim 9, wherein the transmitted cell measurement-related information further includes second information associated with the one or more second cells, the second information indicative of a search window for synchronization signal blocks (SSBs), a list of second cells that are detectable by the first UE, a power change of a second cell, a list of second cells that are not to be considered for cell reselection, or any combination thereof.

13. The first UE of claim 1, wherein, to transmit the cell measurement-related information, the one or more processors are individually or collectively operable to execute the code to cause the first UE to:
transmit the cell measurement-related information via a broadcast channel, a sidelink channel, a wireless local-area network (WLAN), a Bluetooth link, or any combination thereof.

14. The first UE of claim 1, wherein the threshold distance is associated with a set of one or more beams of the network entity, the first UE and the one or more second UEs being located within the set of one or more beams.

15. The first UE of claim 1, wherein the threshold distance is associated with a set of one or more cells of the network entity, the first UE and the one or more second UEs being located within the set of one or more cells of the network entity.

16. The first UE of claim 1, wherein at least one of the first UE or the one or more second UEs are in a radio resource control (RRC) inactive mode.

17. The first UE of claim 1, wherein the one or more processors are individually or collectively further operable to execute the code to cause the first UE to:
determine to transmit the cell measurement-related information based at least in part on a battery level of the first UE, a connection state of the first UE, a capability of the first UE, or any combination thereof.

18. The first UE of claim 1, wherein transmitting the cell measurement-related information to the one or more second UEs is based at least in part on the first UE satisfying a policy defined by the network entity.

19. The first UE of claim 1, wherein the one or more processors are individually or collectively further operable to execute the code to cause the first UE to:
transmit, via the cell measurement-related information, capability information associated with the first UE, the capability information comprising one or more supported frequency bands, a power capability, an antenna configuration, or any combination thereof.

20. The first UE of claim 1, wherein the one or more processors are individually or collectively further operable to execute the code to cause the first UE to:
transmit, via the cell measurement-related information, first information associated with performing the first cell search operation, the first information indicative of one or more searched frequency ranges, one or more searched cell identifiers, or both, wherein the second cell search operation is simplified based at least in part on transmitting the first information.

21. The first UE of claim 1, wherein the one or more processors are individually or collectively further operable to execute the code to cause the first UE to:
transmit, via the cell measurement-related information, an indication of one or more frequency ranges, one or more cells, one or more beams, or any combination thereof for which the one or more second UEs are to deprioritize search operations, wherein the second cell search operation is simplified based at least in part on transmitting the indication.

22. The first UE of claim 1, wherein the cell measurement-related information is associated with a first subset of synchronization signal blocks (SSBs) of a plurality of SSBs associated with the first cell, and the one or more processors are individually or collectively further operable to execute the code to cause the first UE to:
receive, from one of the one or more second UEs, second information associated with a second subset of SSBs of the plurality of SSBs different than the first subset of SSBs.

23. The first UE of claim 1, wherein the cell measurement-related information is associated with a first portion of system information associated with the first cell, and the one or more processors are individually or collectively further operable to execute the code to cause the first UE to:
receive, from one of the one or more second UEs, second information associated with a second portion of the system information associated with the first cell different than the first portion.

24. The first UE of claim 1, wherein the first UE and the one or more second UEs are not associated with a UE to network (U2N) relay framework.

25. A second user equipment (UE), comprising:
one or more memories storing processor-executable code; and
one or more processors coupled with the one or more memories and individually or collectively operable to execute the code to cause the second UE to:
receive, from a first UE of a set of UEs, cell measurement-related information that facilitates selecting a first cell associated with a network entity, wherein the first UE and the second UE are included in the set of UEs based at least in part on the first UE and the second UE being within a threshold distance of each other; and
establish a connection with the network entity in accordance with the cell measurement-related information received from the first UE.

26. The second UE of claim 25, wherein the one or more processors are individually or collectively further operable to execute the code to cause the second UE to:
receive system information that facilitates selecting the first cell, wherein establishing the connection with the network entity is further in accordance with the system information.

27. The second UE of claim 26, wherein the one or more processors are individually or collectively further operable to execute the code to cause the second UE to:
transmit, to the first UE, a request for the system information, wherein receiving the system information is based at least in part on transmitting the request.

28. The second UE of claim 25, wherein the received cell measurement-related information comprises cell measurement configuration information associated with the first cell, cell measurement result information associated with the first cell, first information associated with one or more synchronization signals of the first cell, second information associated with a reference signal of the first cell, or any combination thereof.

29. The second UE of claim 25, wherein, to establish the connection, the one or more processors are individually or collectively operable to execute the code to cause the second UE to:
apply one or more first offsets to the cell measurement-related information received from the first UE, the one or more first offsets including a time offset, a frequency offset, a range-based offset, a synchronization signal block (SSB) index offset, or any combination thereof.

30. The second UE of claim 25, wherein, to establish the connection, the one or more processors are individually or collectively operable to execute the code to cause the second UE to:
utilize, as part of a cell selection operation, a same synchronization signal block (SSB) index as an SSB index included in the received cell measurement-related information to establish the connection.

31. The second UE of claim 25, wherein, to establish the connection, the one or more processors are individually or collectively operable to execute the code to cause the second UE to:
evaluate, as part of a cell selection operation, a subset of synchronization signal blocks (SSBs) of a plurality of SSBs associated with the first cell, the subset of SSBs based at least in part on an SSB index included in the received cell measurement-related information.

32. The second UE of claim 25, wherein the cell measurement-related information further facilitates selecting one or more second cells different than the first cell, the cell measurement-related information including priority information associated with the first cell and the one or more second cells, frequency information associated with the first cell and the one or more second cells, or any combination thereof.

33. The second UE of claim 32, wherein the one or more processors are individually or collectively further operable to execute the code to cause the second UE to:
select a second cell of the one or more second cells based at least in part on receiving the cell measurement-related information.

34. The second UE of claim 32, wherein the cell measurement-related information is further indicative of a search window for synchronization signal blocks (SSBs), a list of second cells that are detectable by the first UE, a power change of a second cell, a list of second cells that are not to be considered for cell reselection, or any combination thereof.

35. The second UE of claim 25, wherein, to receive the cell measurement-related information, the one or more processors are individually or collectively operable to execute the code to cause the second UE to:
receive the cell measurement-related information via a broadcast channel, a sidelink channel, a wireless local-area network (WLAN), a Bluetooth link, or any combination thereof.

36. The second UE of claim 25, wherein the threshold distance is associated with a beam of the network entity, the first UE and the second UE being located within the beam.

37. The second UE of claim 25, wherein the threshold distance is associated with a cell of the network entity, the first UE and the second UE being located within the cell.

38. The second UE of claim 25, wherein the first UE or the second UE are in a radio resource control (RRC) inactive mode.

39. The second UE of claim 25, wherein the one or more processors are individually or collectively further operable to execute the code to cause the second UE to:
transmit the cell measurement-related information to one or more third UEs based at least in part on receiving the cell measurement-related information, wherein the second UE and the one or more third UEs are within a second threshold distance of each other.

40. The second UE of claim 25, wherein establishing the connection in accordance with the received cell measurement-related information is based at least in part on the second UE satisfying a policy defined by the network entity.

41. The second UE of claim 25, wherein the one or more processors are individually or collectively further operable to execute the code to cause the second UE to:
receive, via the cell measurement-related information, capability information associated with the first UE, the capability information comprising one or more supported frequency bands, a power capability, an antenna configuration, or any combination thereof.

42. The second UE of claim 25, wherein the one or more processors are individually or collectively further operable to execute the code to cause the second UE to:
receive, via the cell measurement-related information, first information associated with one or more searching operations performed by the first UE, the first information including one or more searched frequency ranges, one or more searched cell identifiers, or both.

43. The second UE of claim 25, wherein the one or more processors are individually or collectively further operable to execute the code to cause the second UE to:
receive, via the cell measurement-related information, an indication of one or more frequency ranges, one or more cells, one or more beams, or any combination thereof for which the second UE is to deprioritize search operations.

44. The second UE of claim 25, wherein the cell measurement-related information is associated with a first subset of synchronization signal blocks (SSBs) of a plurality of SSBs associated with the first cell, and the one or more processors are individually or collectively further operable to execute the code to cause the second UE to:
obtain second information associated with a second subset of SSBs of the plurality of SSBs different than the first subset of SSBs; and
transmit the second information to the first UE, one or more third UEs, or both.

45. The second UE of claim 25, wherein the cell measurement-related information is associated with a first portion of system information associated with the first cell, and the one or more processors are individually or collectively further operable to execute the code to cause the second UE to:
obtain a second portion of the system information associated with the first cell different than the first portion; and
transmit second information including the second portion of the system information to the first UE, one or more third UEs, or both.

46. A network entity, comprising:
one or more memories storing processor-executable code; and
one or more processors coupled with the one or more memories and individually or collectively operable to execute the code to cause the network entity to:
output, to a first user equipment (UE), cell measurement-related information that facilitates selection of a cell associated with the network entity, wherein the network entity is configured to communicate with a set of UEs including the first UE and one or more second UEs, and wherein the first UE and the one or more second UEs are included in the set of UEs based at least in part on the first UE and the one or more second UEs being within a threshold distance of each other; and
establish a connection with the one or more second UEs based at least in part on outputting the cell measurement-related information to the first UE.

47. The network entity of claim 46, wherein the one or more processors are individually or collectively further operable to execute the code to cause the network entity to:
refrain from outputting the cell measurement-related information to the one or more second UEs, wherein establishing the connection with the one or more second UEs is based at least in part on the refraining.

48. The network entity of claim 46, wherein the cell measurement-related information includes cell measurement configuration information.

49. The network entity of claim 48, wherein the cell measurement configuration information includes a policy defined by the network entity, the policy identifying one or more conditions that are to be satisfied by the first UE, and wherein establishing the connection is based at least in part on the policy.

50. The network entity of claim 46, wherein the one or more processors are individually or collectively further operable to execute the code to cause the network entity to:
output, to the first UE, system information that facilitates selection of the cell, wherein establishing the connection with the one or more second UEs based at least in part on outputting the system information.

51. The network entity of claim 50, wherein, the one or more processors are individually or collectively further operable to execute the code to cause the network entity to:
refrain from outputting the system information to the one or more second UEs, wherein establishing the connection with the one or more second UEs is based at least in part on the refraining.

52. The network entity of claim 50, wherein, to output the system information, the one or more processors are individually or collectively operable to execute the code to cause the network entity to:
output the system information during a connection establishment operation with the first UE; or
output the system information based at least in part on a network configuration change at the network entity.

53. The network entity of claim 50, wherein the one or more processors are individually or collectively further operable to execute the code to cause the network entity to:
receive, from the first UE, a request for the system information, wherein outputting the system information is based at least in part on receiving the request.

54. The network entity of claim 46, wherein the one or more processors are individually or collectively further operable to execute the code to cause the network entity to:
establish a second connection with the first UE based at least in part on outputting the cell measurement-related information to the first UE.

55. The network entity of claim 46, wherein, to output the cell measurement-related information, the one or more processors are individually or collectively operable to execute the code to cause the network entity to:
output one or more system information blocks (SIBs) associated with the cell that include first information associated with one or more second cells different than the cell, the cell measurement-related information including the first information.

56. The network entity of claim 55, wherein the first information includes priority information associated with the one or more second cells, frequency information associated with the one or more second cells, or both.

57. A method for wireless communications at a first user equipment (UE), comprising:
performing a first cell search operation to initiate selection of a first cell associated with a network entity;
obtaining cell measurement-related information that facilitates performance, by one or more second UEs of a set of UEs, of a second cell search operation to initiate selection of the first cell based at least in part on performing the first cell search operation, wherein the second cell search operation is simplified with respect to the first cell search operation; and
transmitting the cell measurement-related information to the one or more second UEs of the set of UEs based at least in part on obtaining the cell measurement-related information, wherein the first UE and the one or more second UEs are included in the set of UEs based at least in part on the first UE and the one or more second UEs being within a threshold distance of each other.

58. A method for wireless communications at a second user equipment (UE), comprising:
receiving, from a first UE of a set of UEs, cell measurement-related information that facilitates selecting a first cell associated with a network entity, wherein the first UE and the second UE are included in the set of UEs based at least in part on the first UE and the second UE being within a threshold distance of each other; and
establishing a connection with the network entity in accordance with the cell measurement-related information received from the first UE.

59. A method for wireless communications at a network entity, comprising:
outputting, to a first user equipment (UE), cell measurement-related information that facilitates selection of a cell associated with the network entity, wherein the network entity is configured to communicate with a set of UEs including the first UE and one or more second UEs, and wherein the first UE and the one or more second UEs are included in the set of UEs based at least in part on the first UE and the one or more second UEs being within a threshold distance of each other; and
establishing a connection with the one or more second UEs based at least in part on outputting the cell measurement-related information to the first UE.
